(19) United States
(12) Patent Application Publication
(10) Pub. No.: US 2025/0193259 A1
(43) Pub. Date: Jun. 12, 2025

(54) PRE-SCHEDULING OF SHARED CONTENT WITHIN A MULTI-USER LIVE STREAM WITH ENHANCED PRESENTATION INTERACTION, CONTENT FEEDBACK AND REVISION GUIDANCE

(71) Applicant: Adeia Guides Inc., San Jose, CA (US)

(72) Inventors: Charles Dasher, Lawrenceville, GA (US); Christopher Phillips, Hartwell, GA (US); Jean-Yves Couleaud, Mission Viejo, CA (US); Tao Chen, Palo Alto, CA (US)

(21) Appl. No.: 18/533,765

(22) Filed: Dec. 8, 2023

(51) Int. Cl. H04L 65/403; G10L 15/22; G10L 15/26; G10L 15/30; H04L 12/18

(52) U.S. Cl. CPC H04L 65/403; G10L 15/22; G10L 15/26; G10L 15/30; H04L 12/1818; H04L 12/1831; G10L 2015/223

(57) ABSTRACT

Systems, methods, and apparatuses are described for enhancing a user experience in event live streaming applications such as video conferencing systems. In an example, first and second virtual meetings are scheduled, each meeting scheduled to include a presentation of the same document. The document is stored in a cloud storage and is associated with both the first meeting and the second meeting. During the first meeting and the second meeting, respective virtual meeting communication data is captured and stored in the cloud storage as metadata associated with the document, and associated with the respective first or second meeting during which it was captured. After the meetings conclude, a user accesses the document and is presented with an option to view the metadata associated with the first or second meeting.

### BACKGROUND

This disclosure is directed to systems and methods for enhancing the user experience for live streaming applications such as video conferencing systems, by providing the ability to pre-share materials to be presented, and providing improved functionality before, during, and after a virtual meeting occurs. In an embodiment, commentary (e.g., audio, video, and other data) received during presentation of materials in a virtual meeting (or links to such commentary) are embedded within the materials themselves. After the virtual meeting concludes, a user may access the commentary along with the shared materials in the shared materials' native format. Embodiments relate to other aspects as well.

### SUMMARY

Modern advancements in live streaming and video conferencing platforms enable the presentation of materials through real-time screen sharing or application-specific document presentations. In one approach, a document is attached via an email, event invitation, or meeting invitation, which is circulated to meeting participants via a calendar application, and during the meeting, one of the participants, such as the meeting host, may share his or her screen during the meeting such that all the participants may view the host's screen that is displaying the document or presentation. However, in such an approach, any updates made to the particular document (before, during or after the meeting) would not be reflected in the document attached to the meeting invite; rather, a new or updated meeting invite (with such update input by a user) would need to be re-circulated to the participants, which consumes additional computing resources. Moreover, it may be inefficient or confusing for a user to navigate through multiple different meeting invites in an effort to find the most up to date document discussed during one of the meetings. Further, in the aforementioned approach, the calendar application does not have a mechanism for efficiently determining whether the same document is attached to multiple different meeting invites and/or was presented during multiple different meetings, let alone associating metadata from the multiple meetings with such a document.

Additionally, when a live stream or video conference is scheduled, organizers and participants, despite having a predefined agenda and associated materials, encounter the limitation of not being able to preload or schedule these materials for presentation. In some approaches, content may be attached via an email, event invitation, or meeting invitation, which may require the materials to remain within the email or calendar application. However, this approach limits the functionality available with respect to the meeting materials, and often makes use of an inefficient and cumbersome process for presenting materials during the meeting. When a presenter wishes to present a document, for example, the presenter may be required to activate sharing from their device, locate the correct application and/or document to be shared (which may require the presenter to have local access to the particular document), and select the appropriate window or portion of a screen. Additionally, such an approach often makes presenting documents particularly difficult for presenters who are not accessing the meeting via a computer, who may be travelling, are accessing the meeting via a mobile phone or device with a small screen, or are accessing the meeting via a device without access to the meeting materials.

Furthermore, when a meeting is recorded, the recording may provide audio and/or video of the meeting, but this audio and/or video is not tied to the files or documents that were presented. Similarly, accessing the presented materials after the meeting does not provide audio, video, or other data shared during the meeting that corresponds to the files or documents that were presented during the meeting itself. In such an approach, separate applications may be required for a user to access both the meeting recording and related documents or files storing content that was presented during the meeting.

Embodiments of the present disclosure address these problems and more by creating a shared storage (e.g., a cloud storage) in which a particular document is stored, along with the audio, video, and other data captured during the virtual meeting(s) in which the particular document is presented. Then, when a user wants to review the particular document and the corresponding audio (or other data), the user may be presented with an option to access the particular document along with the audio, video, and/or other information from the particular virtual meeting in which the user was a participant. If a user presents a particular document in multiple virtual meetings, the cloud storage may enable the user to view a list of all the virtual meetings in which the particular document was presented and in which the user was a participant (or otherwise has been granted access), enabling the user to select a particular virtual meeting and related discussion.

Additionally, embodiments of the present disclosure may enable a user to pre-share materials intended to be presented during the virtual meeting. The materials may be uploaded to a cloud storage corresponding to the scheduled virtual meeting. During the virtual meeting itself, the materials may be presented to all participants by accessing the materials in the cloud storage, rather than requiring the presenter to access the particular document locally and share their screen. Presentation of the materials from the cloud storage reduces the bandwidth requirements of the presenter, which can provide significant benefits for users with limited data plans or poor connectivity. Additionally, access to the particular document via the cloud storage may enable other participants and/or the virtual meeting host, in addition to the presenter of the particular document, to control the presentation of the particular document. For presenters that are experiencing technical issues, who are accessing the virtual meeting via phone or other mobile device, or are otherwise having difficulty presenting, the host or another participant may be granted access to control the presentation of the particular document (e.g., flipping slides, changing pages, etc.). Additionally, embodiments of the present disclosure may enable voice control of the presentation of the particular document via the cloud storage. For a presenter accessing the virtual meeting via phone or other mobile device, this may enable the presenter to control presentation of the particular document by saying “next slide” without requiring the presenter to manually interact with their device to click or select the next slide.

Furthermore, embodiments of the present disclosure may associate the materials (e.g., documents or files storing content that was presented during a virtual meeting) to the commentary (e.g., virtual meeting communication data) that occurred during the virtual meeting, including for example the virtual meeting audio, video, and/or text such as chat, reactions, and more. The disclosed methods and systems may generate a timeline, list, or other type of organized structure that provides an organized recap of the virtual meeting, allowing users to revisit and review specific content segments alongside the associated commentary. In some examples, the virtual meeting communication data captured during the virtual meeting may be associated with the corresponding portions of the particular document itself (e.g., particular pages, slides, paragraphs, sentences, figures, etc.), thereby allowing a user to review the particular document and related commentary at a later time, even out of order with respect to the virtual meeting presentation. That is, there may be an ordered timeline created based on the order of presentation during the virtual meeting, or there may be another type of structure created to link the materials presented during the meeting to the related commentary that occurred with respect to those materials (even if the materials were presented out of order). By associating (e.g., embedding or linking) particular segments of commentary with relevant portions of content, the user may quickly view a particular portion of the document and determine what, if any, relevant commentary has been provided with respect to that portion. Disclosed embodiments may also transcribe the commentary during the virtual meeting (e.g., using AI powered Natural Language Processing) to generate a transcription of the conversations that occur during the virtual meeting. The transcription may be analyzed to determine specific comments, suggestions, and/or other commentary that pertains to portions of the presented materials. The methods and systems disclosed herein may then link those comments, suggestions, and/or commentary as well as who provided the comments to the presented materials as native comments within the presented document (e.g., as review comments in a Microsoft Word document). When a participant reviews the particular document after the virtual meeting, the discussions that occurred during the virtual meeting with respect to particular portions of the particular document may be easily identified within the native document application. Furthermore, the methods and systems may identify edit suggestions from the transcribed commentary, may prepare a preview of the particular document including the identified edit suggestions (e.g., using a large language model), and/or may generate a checklist of the edit suggestions identified during the virtual meeting. A participant of the virtual meeting may then access the checklist when they review the particular document after the virtual meeting.

In light of the drawbacks noted above with respect to user experience before, during, and after a virtual meeting, systems and methods are provided herein for improving user experience with respect to virtual meetings, and adding additional functionality with respect to presenting documents and accessing presented documents after a virtual meeting concludes. A method includes receiving an input to schedule a first virtual meeting, wherein the first virtual meeting is scheduled to include a first plurality of participants including a first participant associated with a first computing device and a second participant associated with a second computing device, the first and second devices being connected via a network to a server providing the first virtual meeting. The method also includes receiving, prior to a start of the first virtual meeting, a particular document to be presented to the plurality of participants during the first virtual meeting, and storing the particular document in a cloud storage associated with the first virtual meeting. It should be appreciated that cloud storage may also include local storage for a business or entity who wishes to control access to documents and virtual meeting communication data. In some examples, a linking mechanism may be used so that a document stored in a controlled cloud environment may be temporarily accessed by a server controlled by the virtual meeting provider (if different from the entity in control of the document storage). Additionally, some entities may elect to use their own infrastructure (on-premises) for both storage of materials and videoconference capabilities. Examples in this disclosure that reference “cloud” storage should be interpreted broadly to include on-premises storage.

The method also includes storing, at the cloud storage as first metadata associated with the particular document, virtual meeting communication data captured via at least one of the first plurality of computing devices while the particular document is being presented at the first virtual meeting. The method further includes determining that a second virtual meeting is scheduled to occur during which the particular document is scheduled to be presented, the second virtual meeting including a second plurality of participants, wherein the second plurality of participants includes the first participant. The method also includes storing, at the cloud storage as second metadata associated with the particular document, virtual meeting communication data captured via at least one of the second plurality of computing devices while the particular document is being presented at the second virtual meeting. The method still further includes causing display, at the first computing device, a first option to access, via the first metadata stored at the cloud storage, the first virtual meeting communication data captured while the particular document was presented during the first virtual meeting; and a second option to access, via the second metadata stored at the cloud storage, the second virtual meeting communication data captured while the particular document was presented during the second virtual meeting.

Such a method enables an improved user experience regarding how, within the context of a virtual meeting, content is created, stored, and referenced by the presentation document. Commentary during the virtual meeting, as well as commentary with respect to the particular document in other virtual meetings, is maintained within the particular document as associated metadata. All content may be stored in the cloud and encrypted, enabling participant access before, during, and after the virtual meeting. If the same particular document is presented in multiple virtual meetings, the commentary corresponding to each virtual meeting may be individually accessible by the participants in that virtual meeting. If a participant is present for multiple virtual meetings in which a given document is presented, the participant may have the ability to select which virtual meeting and which corresponding commentary to access after the virtual meetings conclude.

In some embodiments, the method further comprises assigning permissions associated with the particular document for the first plurality of participants based on a status of each of the first plurality of participants with respect to the virtual meeting, wherein the permissions permit access to control presentation of the particular document during the first virtual meeting. The method then includes, during the first virtual meeting: receiving a request to present the particular document from the first participant; and in response to determining that a first permission corresponding to the first participant permits the first participant to control presentation of the particular document: (1) accessing the particular document stored in the cloud storage; and (2) providing the particular document for display on each computing device of the first plurality of participants. These steps enable all approved participants to control presentation of the particular document in the cloud storage, meaning that the presenter need not have a local copy of the particular document itself.

In some embodiments, the first virtual meeting is scheduled to include at least three participants, wherein the first participant is a host of the virtual meeting, and the second participant is an author of the particular document. In this case, the method may further comprise assigning, to the host of the first virtual meeting, permission to control presentation of the particular document during the first virtual meeting; assigning, to the author of the particular document, permission to control presentation of the particular document during the virtual meeting; and assigning, to all other participants, permissions that prevent control of the presentation of the particular document during the virtual meeting. This enables both the host and the presenter to control the presentation of the particular document, which may be beneficial for virtual meetings in which the presenter is unable to or has difficulty directly controlling the presentation. In some embodiments, the method may further comprise, during the virtual meeting, receiving a voice command from the author or other presenter of the particular document, and controlling presentation of the particular document based on the voice command. This enables a presenter attending the virtual meeting via phone to still be able to control the presentation.

In some embodiments, the method further comprises, during presentation of the particular document during the first virtual meeting, transcribing the audio data captured via the at least one of the first plurality of computing devices; identifying, in the transcribed audio data, a comment associated with a first portion of the particular document; and storing, at the cloud storage as third metadata, the comment associated with the first portion of the particular document. When, after the first virtual meeting ends, a participant later wants to review what happened during the virtual meeting with respect to the particular document, the participant may access the particular document in its native application. The particular document may include native comments based on what was discussed during the virtual meeting.

Associating comments with portions of the particular document may be done in any number of ways. For example, a large language model and/or common theme/word analysis may be performed to identify the portion(s) of a particular document referred to by each comment. In this way, a comment may not only be connected to the document being presented, but to the specific portion or portions of the document to which the comment refers, even if a relevant portion of the particular document is not being presented when the comment is made.

In some embodiments, the method further comprises, during presentation of the particular document: identifying, based on the audio data captured via the at least one of the first plurality of computing devices, a suggestion to modify a portion of the particular document; generating for display a preview of the portion of the particular document including the recommended modification; and generating for display, a prompt requesting a selection to accept or reject the recommended modification. For example, if a participant says “make paragraph three bold,” the method may include identifying and linking the suggestion to modify paragraph three to bolden the text with the particular document at paragraph three, and generate a preview of paragraph three in bold font along with a prompt to accept or reject the modification. The association between the participant's comment and the portion of the document (e.g., paragraph three) may be made using a large language model, and/or common theme/word analysis, for example. This functionality may enable more collaborative and efficient review of documents during the virtual meeting, by enabling some or all participants to view the suggested edits as they are made. If the presenter or another permitted participant elects to accept the modification, the method may include modifying the particular document in the cloud storage to include the recommended modification. In another example, if a participant says “change X to Y everywhere in the document,” the comment may be associated with all instances of X in the document. The presenter or another party may also be provided with an option to automatically perform the edit, to change all instances of X to Y within the document.

In some embodiments, the method further comprises, during presentation of the particular document during the first virtual meeting, transcribing the audio data captured via the at least one of the first plurality of computing devices; identifying one or more recommended modifications to the particular document included in the transcribed audio data; generating a list of action items associated with the particular document, the action items based on the one or more recommended modifications included in the transcribed audio data; and storing the list of action items associated with the particular document in the cloud storage. This may enable a participant to, during or after the virtual meeting ends, access a checklist of action items that were discussed during the virtual meeting. The checklist may provide the presenter or other participants with a list of all the suggestions made during the virtual meeting, without requiring the presenter to take notes or otherwise manually make a list. Furthermore, in some embodiments, each of the action items in the list of action items are associated with a corresponding portion of the particular document, and the list of actions items are stored in the cloud storage as third metadata associated with the particular document. This further connects the particular document presented during the virtual meeting with the commentary from the virtual meeting, and the list of action items that were identified from the commentary during the virtual meeting.

In some embodiments, the same document may be presented in multiple virtual meetings, and there may be multiple versions of commentary with respect to the same document. Additionally, a participant may be included in multiple virtual meetings in which the same document is presented (e.g., the presenter). In this case, the particular document stored in the cloud storage may be associated with two or more distinct virtual meetings with their own distinct commentaries. When a participant later wishes to review the particular document and/or virtual meeting communication data, they may have the option to review the particular document along with one of several possible commentaries, based on which virtual meeting(s) that participant was invited to. The method may include determining a virtual meeting permission for the participant based on whether the participant was invited to a first virtual meeting or a second virtual meeting (and/or whether the participant was granted access without having attended one or both meetings); and based on the virtual meeting permission for the participant, enabling the participant to access either the first commentary data (corresponding to the first virtual meeting) or the second commentary data (corresponding to the second virtual meeting) associated with the particular document.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A depicts an illustrative block diagram for scheduling a virtual meeting, presenting a particular document during the virtual meeting, and storing commentary along with the presented document, in accordance with some embodiments of this disclosure.

FIG. 1B depicts an illustrative block diagram for accessing commentary associated with a particular document presented during multiple virtual meetings, in accordance with some embodiments of this disclosure.

FIGS. 2A-C depicts illustrative diagrams showing techniques for adding a particular document to a shared storage for a scheduled virtual meeting, in accordance with some embodiments of this disclosure.

FIG. 3 depicts an illustrative user interface of a calendar application indicating that materials may be added to a shared storage for an upcoming event, in accordance with some embodiments of this disclosure.

FIG. 4 depicts an illustrative user interface of a widget indicating that materials have been shared for an upcoming event, in accordance with some embodiments of this disclosure.

FIG. 5 depicts an illustrative sequence diagram for enabling a user to schedule a virtual meeting and add materials to be presented during the virtual meeting, in accordance with some embodiments of this disclosure.

FIG. 6 depicts an illustrative sequence diagram for enabling documents or other materials to be added to the shared storage and then accessed for presentation during the virtual meeting, in accordance with some embodiments of this disclosure.

FIG. 7 depicts an illustrative sequence diagram for enabling a presenter to use their voice to control presentation of content during a virtual meeting, in accordance with some embodiments of this disclosure.

FIG. 8 depicts an illustrative sequence diagram for commentary and metadata related to the presentation of documents and/or files during a virtual meeting are identified and stored in the shared storage, in accordance with some embodiments of this disclosure.

FIG. 9 depicts an illustrative user interface for enabling a user to select commentary from one of several virtual meetings in which a given document was presented, in accordance with some embodiments of this disclosure.

FIG. 10 depicts an illustrative block diagram of a system architecture showing various interfaces for a virtual meeting presenter to pre-share a particular document to the shared storage and/or present the particular document while the virtual meeting is in progress, in accordance with some embodiments of this disclosure.

FIG. 11 depicts an illustrative block diagram of a system architecture showing various interfaces for a user to view a particular document presented during a virtual meeting, and select within the particular document whether to present commentary on a per user basis, in accordance with some embodiments of this disclosure.

FIG. 12 depicts an illustrative sequence diagram for enabling segmenting of materials presented during a virtual meeting, in accordance with some embodiments of this disclosure.

FIG. 13 depicts an illustrative sequence diagram for enabling commentary received during a virtual meeting to be analyzed and stored as native comments within the presented materials, in accordance with some embodiments of this disclosure.

FIG. 14 depicts an illustrative sequence diagram enabling the identification of suggested edits to a presented document, in accordance with some embodiments of this disclosure.

FIG. 15 depicts an illustrative user interface for displaying a user's comment within a particular document in its native format, in accordance with some embodiments of this disclosure.

FIG. 16 depicts an illustrative user interface for identifying a suggested modification to a particular presented document, displaying a preview of the particular document including the suggested modification, and displaying a prompt to the presenter to accept or deny the suggested modification, in accordance with some embodiments of this disclosure.

FIG. 17 depicts an illustrative sequence diagram for creating a checklist based on commentary received during a virtual meeting, in accordance with some embodiments of this disclosure.

FIG. 18 is a flowchart of an illustrative process for enhancing the user experience in an event live streaming application, in accordance with some embodiments of this disclosure.

FIGS. 19-20 depict illustrative devices, systems, servers, and related hardware for providing the improved functionality described herein before, during, and after a virtual meeting, in accordance with some embodiments of this disclosure.

### DETAILED DESCRIPTION

As noted above, this disclosure is directed at enhancing the user experience in event live streaming applications such as video conferencing systems by addressing challenges in content sharing, interactivity, and post-event or meeting content management. While many platforms present basic interfaces that require manual content sharing, embodiments disclosed herein endeavor to streamline these processes. Additionally, while some platforms may enable a user to replay a recording of a meeting in which materials were presented, embodiments of the present disclosure provide enhanced functionality. Embodiments disclosed herein tie the virtual meeting communication data including video, audio, and/or text (e.g., text comments and/or transcriptions of meeting audio) to the shared document that was presented during the virtual meeting. This structure enables the various functionality described in detail in this disclosure, such as advanced content sharing through scheduling tools, temporary shared storage (e.g., cloud storage) for content safety, voice command functionality for real-time interactions, and the integration of artificial intelligence for post-event or meeting content feedback and content revision guidance.

As used herein, the terms meeting, virtual meeting, live steam, event, live stream event, session, live stream session, and similar terms may be used interchangeably to refer to the scheduled virtual event during which materials are presented. For simplicity, many of the embodiments described herein use the term virtual meeting for this purpose, but it should be appreciated that other terms may be used as well. In some embodiments, the virtual meeting may be a computer-generated session, such as, for example, a video communication session, a video call or video conference, an audio call, an audio communication session, a chat communication session, an extended reality (XR) session, an XR meeting, an XR game, a multi-player video game, a watch party of a media asset, or any other suitable communication session, or any combination thereof, as between any suitable number of users, for any suitable purpose (e.g., business, medical, entertainment, social, communicative, or any other purpose, or any combination thereof). The virtual meeting may correspond to a two-dimensional (2D) or three-dimensional (3D) environment, or any other suitable environment.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such an environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world, or the real world is otherwise connected to virtual objects.

The terms document, content, materials, shared document, particular document, shared content, shared materials, shared file, and other similar terms may be used interchangeably to refer to one or more documents shared during the virtual meeting. For simplicity, many of the embodiments described herein use the term document for this purpose, but it should be appreciated that other terms may be used as well.

The terms commentary, communication data, virtual meeting communication data, audio, audio data, video, video data, audio visual data, text, closed captioning, subtitles, and other similar terms refer to the input from participants of the virtual meeting with respect to the shared document, as well as the recording of the virtual meeting itself with respect to the shared document. For simplicity, many of the embodiments described herein use the term virtual meeting communication data for this purpose, but it should be appreciated that other terms may be used as well.

The terms cloud storage and shared storage may be used interchangeably in embodiments of this disclosure, to refer to the storage which includes the shared document as well as metadata relating to the communication data with respect to the shared document. In some embodiments, cloud storage may refer to providing on-demand access to a shared pool of configurable computing resources (e.g., networks, servers, storage, applications, and services) that can be provided to clients from one or more local or third-party servers and/or databases. It should be appreciated that while some examples disclosed herein may refer to remote servers or remote storage, it should be appreciated that the same functions and features may also be used in the context of local servers or local storage.

In some embodiments, the virtual meeting discussed in embodiments of this disclosure may be hosted by one or more local or remote servers or on-private infrastructure (e.g., on-premises servers). In some embodiments, the virtual meeting may be scheduled for a particular time or may be spontaneously created at the request of a user, with any suitable number of participants. In some embodiments, each user may access the virtual meeting via a connected computing device (which may be equipped with or otherwise proximate to a camera and a microphone) accessing one or more of a web address or virtual room number, e.g., by entering his or her username and password. In some embodiments, one or more users may be a moderator or host, where a designated moderator may have the task of organizing the virtual meeting and/or selecting the next participant member to speak or present. In some embodiments, the virtual meeting communication data including audio and/or video of the virtual meeting may be recorded, stored (e.g., embedded within the document) and transmitted at a later time to other users and/or posted to any suitable website or application (e.g., a social network, video sharing website application, etc.) for consumption by other users.

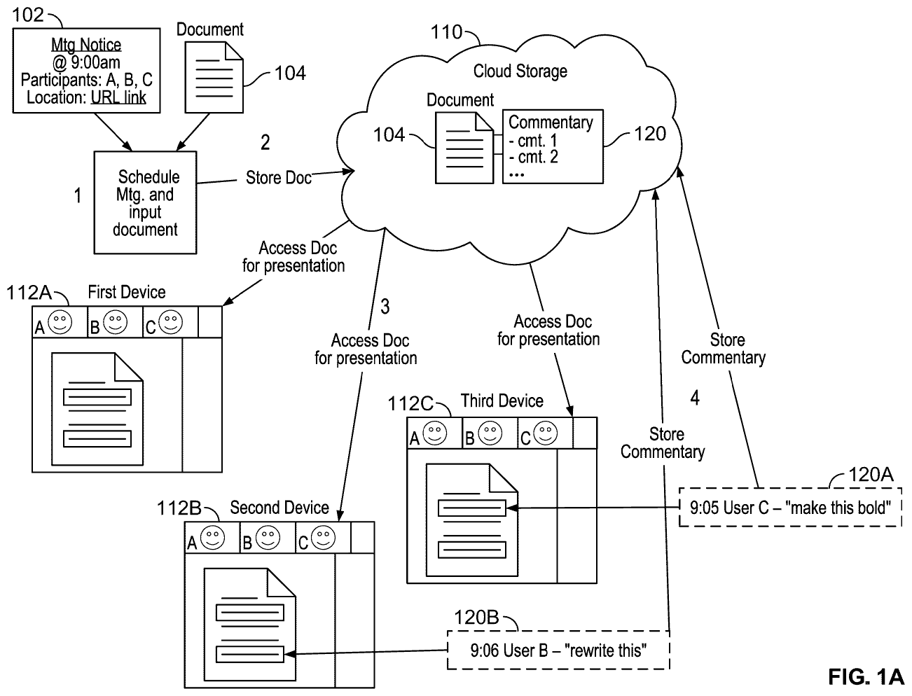

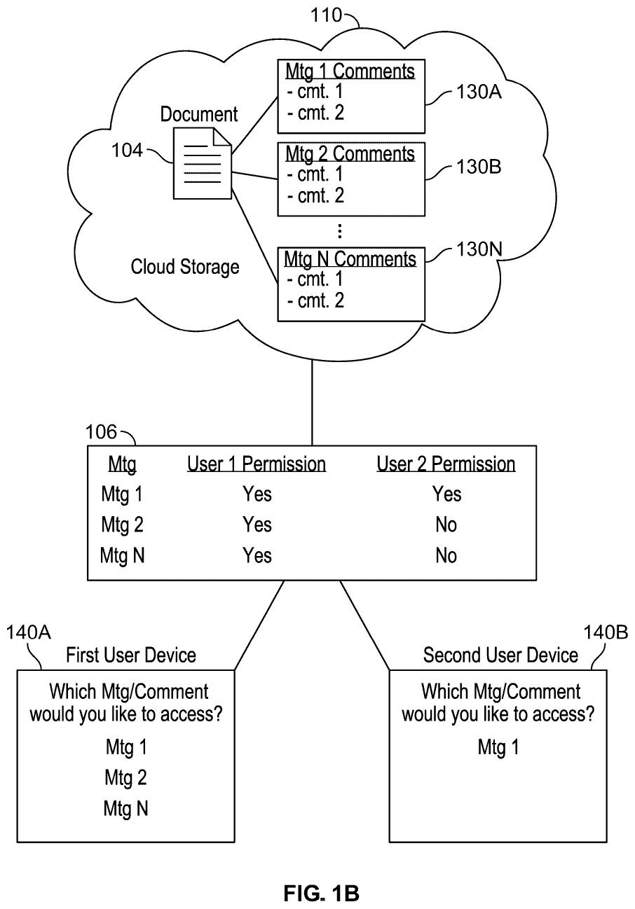

FIG. 1A depicts an illustrative block diagram showing techniques for a system to enable a user to schedule a virtual meeting, present a particular document during the virtual meeting, and store commentary along with (e.g., embedded within) the presented document in the shared storage or cloud storage. As an initial step, the user may initiate a live stream event session, such as a video conference or virtual meeting. As used herein, the term “virtual meeting” may be used to refer to any type of live stream event session or video (and/or audio and/or textual) conference session. A user may schedule a virtual meeting through a calendar application or function, by setting a time, location (e.g., virtual meeting room), and invited participants. As shown in FIG. 1A at block 102, the user has scheduled a virtual meeting for participants A, B, and C at 9:00 am. The user also designated a particular document or file 104 to be shared during the virtual meeting. As used herein, the terms “document” or “content” may be used to refer to one or more computer-based files that may be shared during a virtual meeting, such as text-based files, slide presentations, worksheets or workbooks, videos, images, or any other suitable file, or any combination thereof.

In some embodiments, a virtual meeting system may provide a virtual meeting application to execute at, for example, one or more remote cloud servers (e.g., cloud storage 110 and/or server 2003 and/or database 2005); one or more computing devices 112A, 112B and 112C of users participating in the virtual meeting; and/or at any other suitable computing devices; or any combination thereof. One or more servers may facilitate the virtual meeting by way of a connection over one or more networks (e.g., the Internet). The virtual meeting application may be configured to perform the functionalities described herein. In some embodiments, the virtual meeting system may comprise, correspond to, or be included in a system that further comprises, one or more XR applications, one or more video communication applications and/or audio communication applications and/or other communication applications, one or more streaming media applications, one or more social networking applications, one or more image or video capturing and/or editing applications, one or more image analysis applications, any suitable number of networks, any suitable number of displays, sensors or devices, or any other suitable software and/or hardware components, or any combination thereof.

Once a particular document (e.g., document 104) has been selected for sharing during the scheduled virtual meeting, the virtual meeting system pushes the particular document to a dedicated shared storage environment (e.g., cloud storage 110). The virtual meeting system may also tag the document 104 in the shared storage 110 with access control metadata, as well as temporal markers indicating when the particular document was added, when it can be accessed until, or any other suitable data, or any combination thereof. In some embodiments, storage area 110 may be temporary and may be created to store the particular document and related information from the moment the virtual meeting is created to a predetermined time after the virtual meeting's conclusion.

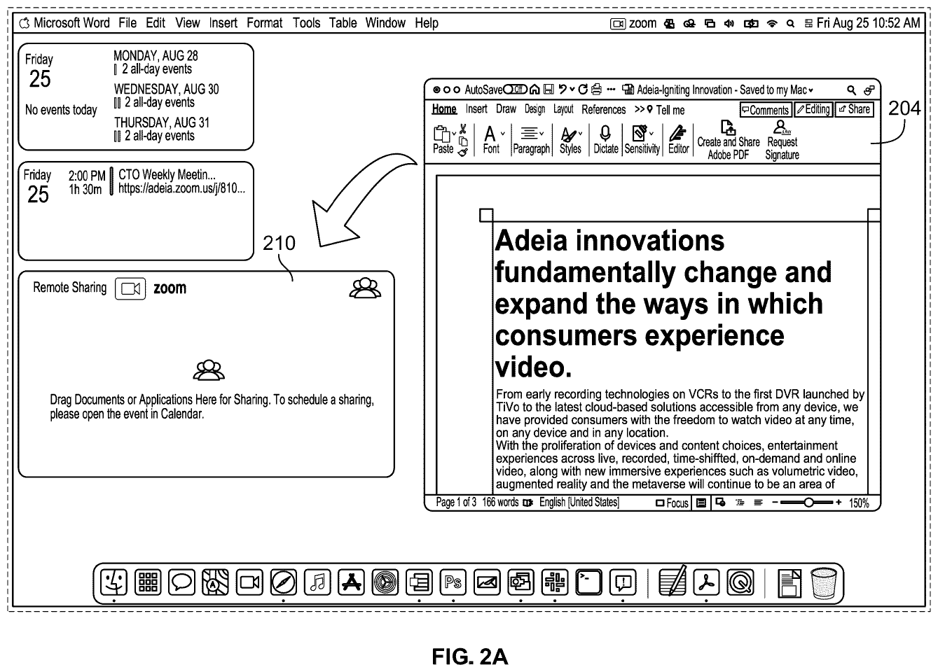

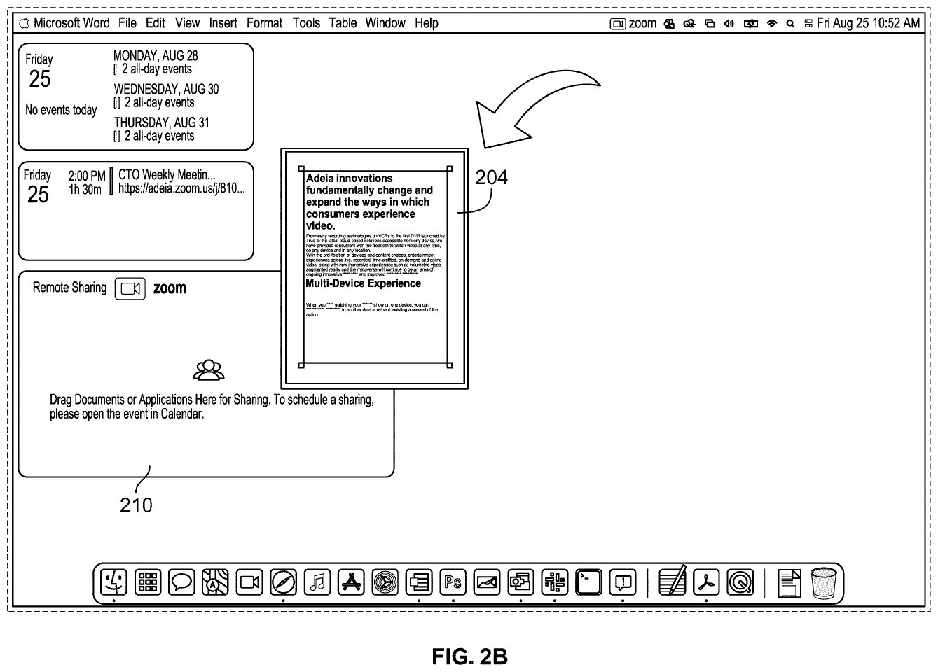

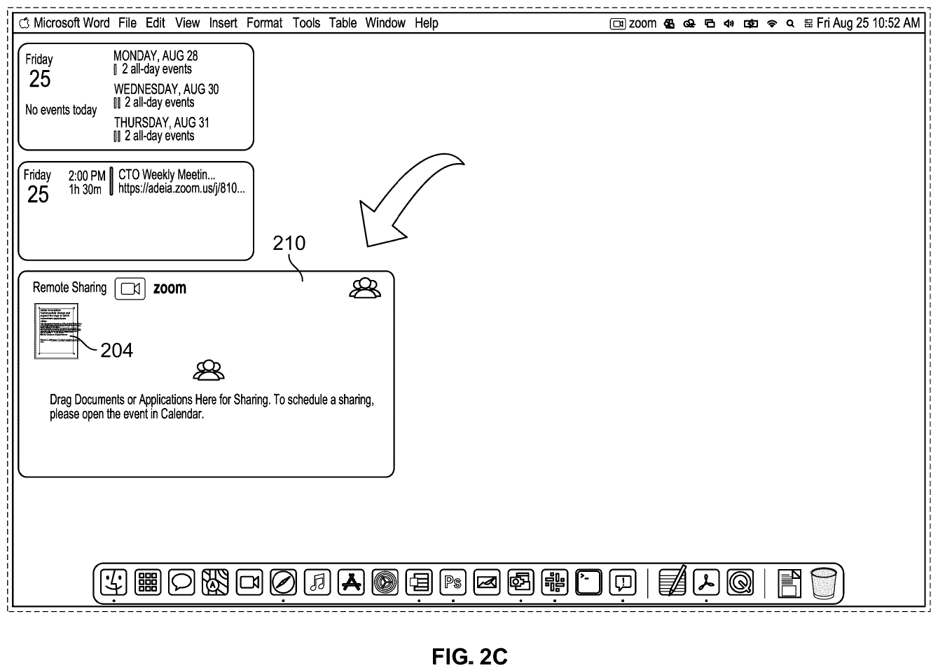

Once the particular document 104 is uploaded to the cloud storage 110, previews of the particular document 104 (such as but not limited to thumbnails) may be generated by the virtual meeting system to be used within the event livestream scheduling application or calendar (for example within an Outlook calendar) to represent the particular document. The preview may function as an anchor to enable accessing URLs or other “clickable” or “selectable” objects which may allow users to view the particular document. This is discussed in further detail below with respect to FIGS. 2A-C.

As time progresses and a current time reaches the start of the scheduled virtual meeting, the participants may join the virtual meeting. During the virtual meeting, the virtual meeting system may access the particular document 104 from the cloud storage 110 for presentation to each computing device 112A, 112B, and 112C of the three participants. In some embodiments, at least two participants may be participating in the virtual meeting via a shared computing device (e.g., in a conference room setting), or each participant may be participating in the virtual meeting via a respective computing device. As the participants speak, type, react, gesture, or otherwise interact during the virtual meeting, their comments (e.g., comments 120A and 120B), and/or other interactions, are received, stored, (and optionally analyzed) along with the particular document 104 in the cloud storage 110. As discussed in further detail below, the comments may be analyzed, either at the time they are received, or at some later time, using AI driven transcription, Natural Language Processing, and/or other techniques, to generate content-based timeline metadata (e.g., tying the comments to the presentation of the particular document during the virtual meeting), to generate edit suggestions for the particular document 104, to create a checklist for the particular document 104, and more. In some examples, the commentary may be captured, embedded/linked with the particular document 104, and analyzed, all during the virtual meeting in real time. In other examples, the analysis (e.g., transcription, actions/edits derivations, edit suggestions, and commentary segmentation) may be performed after the meeting ends. As shown in FIG. 1A, the comments 120A and 120B may be stored as a metadata file 120 in the cloud storage 110, associated with or embedded within the particular document 104 itself. In some examples, the comments may be embedded within the particular document, while in other examples, links to the comments may be embedded within the particular document. In this way, the virtual meeting system enables a user to not only review a virtual meeting after it occurs, but also access the particular document presented during the virtual meeting (e.g., particular document 104), and focus on the commentary that occurred with respect to a given portion of the particular document. That is, rather than requiring a user to sift through a meeting timeline to find the relevant commentary with respect to a portion of the particular document 104, embodiments of the present disclosure enable a user to begin by selecting a portion of the particular document 104, and retrieve all the relevant comments, suggestions, video, audio, etc. that was made with respect to that portion of the particular document, even if the comments occurred out of order, or at multiple different times during the virtual meeting. That is, if participants in a virtual meeting discuss the presented particular document out of order, (e.g., first discussing page 2, then page 3, then page 10, then page 2 again), the comments made with respect to each page (or other subset of the particular document) may be linked or associated with the relevant portion of the particular document itself. Then, after the virtual meeting when a user wishes to review all the relevant comments with respect to a given portion of the shared document, the user is able to access all the relevant comments quickly and easily without having to sift through the virtual meeting recording. In some examples, the reverse is true as well. For example, the user may view a transcript of the virtual meeting, and by selecting a commentary item on the transcript, jump from the transcript directly to portion(s) of the document referred to by that selected commentary item. For instance, the user may search the transcript for their name and have all the sections of the document where their name was mentioned during the meeting highlighted.

In some examples, the particular document 104 and/or associated commentary 120 may be stored in the cloud storage 110 for a limited time after the virtual meeting ends (configurable by the user). Once the post-event duration elapses, the virtual meeting system may remove the particular document 104 and/or related commentary 120, modify their visibility, or otherwise change how the particular document and/or related commentary may be accessed based on preset user preferences or system defaults. In this manner, content security and relevance are maintained. Additionally, notifications may be sent to virtual meeting attendees which update or remove previews or links to expired content from the scheduling application or calendar. For example, a preview of an item may be replaced with a link requesting additional access time for the shared content. In some examples, the particular document 104 and associated commentary 120 may be shared after the meeting with one or more users who were not participants in a meeting in which the particular document 104 was presented. The virtual meeting system may provide an option for a user (e.g., the presenter, meeting organizer, participant, etc.) to share the particular document 104 along with the meeting commentary from one or more meetings in which the particular document 104 was presented. For example, when a user requests access to a document and associated commentary without having been a participant in any of the meetings, the virtual meeting system may provide the document author an option to select one or more meeting commentaries to provide access to along with the document itself. Additionally, there need not be an explicit request in order for the virtual meeting system to provide access, but rather the virtual meeting system may enable a user to proactively choose one or more users (including those who did not participate in any relevant meetings) to whom access should be granted, along with all or a subset of the meeting commentary associated with the document.

FIG. 1B illustrates an example block diagram for accessing commentary associated with a particular document presented during multiple virtual meetings, in accordance with some embodiments of this disclosure. In the illustrated example, the particular document 104 is presented in N separate virtual meetings. When each virtual meeting occurs, the commentary (e.g., text, speech, videos, or any other suitable data, or any suitable combination thereof) pertaining to the particular document 104 is received, analyzed, and stored in the cloud storage 110. The commentary from each virtual meeting may be stored as a corresponding metadata file associated with the particular document 104 (e.g., embedded within the document). For instance, the first virtual meeting commentary is stored as metadata file 130A, the second virtual meeting commentary is stored as metadata file 130B, and the Nth virtual meeting commentary is stored as metadata file 130N.

Each virtual meeting of the plurality of virtual meetings in which the particular document 104 was presented may have a distinct set of participants. That is, the first virtual meeting may include participants A and B, while the second virtual meeting includes participants A and C, etc. The cloud storage 110 may have permissions associated with the particular document 104, and in particular associated with the commentary 130A-N. That is, the permissions for a given user or participant in one or more of the virtual meetings in which the particular document 104 was presented may allow that user or participant to access the particular document 104, and to access the commentary corresponding to the virtual meeting or virtual meetings in which the user or participant was present. As shown in FIG. 1, user 1 was a participant in all of the virtual meetings. This may occur, for example, if user 1 is the presenter of the particular document, and hosted all of the virtual meetings to present to separate groups of people. User 2 was a participant in virtual meeting 1, but was not a participant in any other virtual meetings in which particular document 104 was presented. The permissions 106 reflect that user 1 (i.e., the host and presenter of particular document 104), is permitted to access the commentary from each of the virtual meetings. In contrast, user 2 is only permitted to access the commentary from virtual meeting 1, in which they were a participant.

In some examples, when a user desires to review the particular document 104 and corresponding commentary from one or more virtual meetings in which the user was present (or otherwise permitted to access), the virtual meeting system may display a prompt indicating all virtual meeting commentaries for which that user is permitted to access. This is illustrated in FIG. 1B as user interface 140A for user 1, and user interface 140B for user 2. The virtual meeting system may identify the user requesting access to the particular document and corresponding commentaries, and may responsively identify which virtual meetings the user was present for or invited to, and then provide a prompt to the user indicating the permitted virtual meeting commentaries for that user. The user may then select one or more of the available corresponding commentaries. The commentary may then be reflected as native comments within the document application (e.g., Word comments within a Word document). In some examples, the commentary may take other forms, depending on the type of commentary (e.g., text comments, embedded video, links to videos, etc.).

FIGS. 2A-C illustrate an example technique for a user to add a particular document to a pre-scheduled virtual meeting, which then causes the particular document to be stored in the cloud storage as discussed elsewhere in this disclosure. When a user schedules a virtual meeting, the user may have the ability to share content ahead of the scheduled virtual meeting through a calendar or scheduling application, for example. This pre-sharing mechanism ensures that content is ready for display during the virtual meeting without requiring manual sharing during the actual virtual meeting. In some examples, the particular document may be pre-shared by adding it to the calendar entry for the virtual meeting (e.g., dragging, clicking, or otherwise adding the particular document to the calendar entry). As shown in FIG. 2A, the particular document may be open in a running application (e.g., Word), and the user may drag the particular document into a Desktop “widget” which has been configured by the Operating System to allow its contents to be shared by any Video Conferencing or Live Stream system. This widget may be part of a calendar application, or may be a separate application or program. The widget may enable a user to intuitively interact with the virtual meeting system to add documents that the user wishes to share. In some examples, the particular document may be associated with multiple virtual meetings. When the particular document associated with multiple virtual meetings is added, the cloud storage may store metadata indicating all the virtual meetings to which the particular document is associated. The cloud storage may also include permissions and other information that indicate which users are permitted to access the particular document. Only those users who are part of a virtual meeting's roster (e.g., host or invitee) can access the stored particular document. In some examples, other parties may also be permitted to access the particular document (e.g., the document author, system administrator, etc.). The access to the particular document may be bound by the virtual meeting's timeline based on one or more preferences of the virtual meeting system. For example, a user may be granted access to the particular document in the shared storage beginning when the virtual meeting is created, and ending some predetermined time after the conclusion of the virtual meeting. In some examples, different users (e.g., the document author, virtual meeting host, participants, etc.) may have different respective timelines associated with their ability to access the particular document. In some examples, the timeline during which a user may access the particular document may be altered as an event schedule is altered, for example if a scheduled event time changes, is cancelled or a series of events is cancelled.

FIGS. 2A-C illustrate one example of a user dragging a particular document 204 into the calendar widget 210. However, it should be appreciated that this is one example technique, and many other techniques for adding a particular document to the cloud storage and associating the particular document with the scheduled virtual meeting may be used.

As noted above, the virtual meeting system may use a shared storage or cloud storage to store the particular documents to be presented during a virtual meeting. The pre-shared content for a virtual meeting may be stored in the shared storage from the time of the virtual meeting creation until a predetermined time post-event or meeting, ensuring content accessibility and security. This reduces the upload bandwidth requirements of users during a virtual meeting, which may be important for users that are on a limited data plan or have poor connectivity. Since the particular document is already uploaded to the cloud storage, from which the particular document will be accessed for presentation during the virtual meeting, users are not required to upload the particular document during the virtual meeting itself.

In some examples, the particular document uploaded and stored in the cloud storage may be accessed, modified, and updated before, during, and after the scheduled virtual meeting in which the particular document is presented. For example, the content sharer (e.g., the user who pre-shared the particular document) may update the shared document via the scheduling application or through a new content paradigm (e.g., auto save for meeting) where changes to the particular document are pushed to the version which has been pre-shared. This allows a user to pre-share content, continue to work on it (with an auto save function for example) and when they decide, update the version of the content which was pre-shared. This may enable participants with appropriate permissions to access the updated document without concern for whether they are accessing an outdated version.

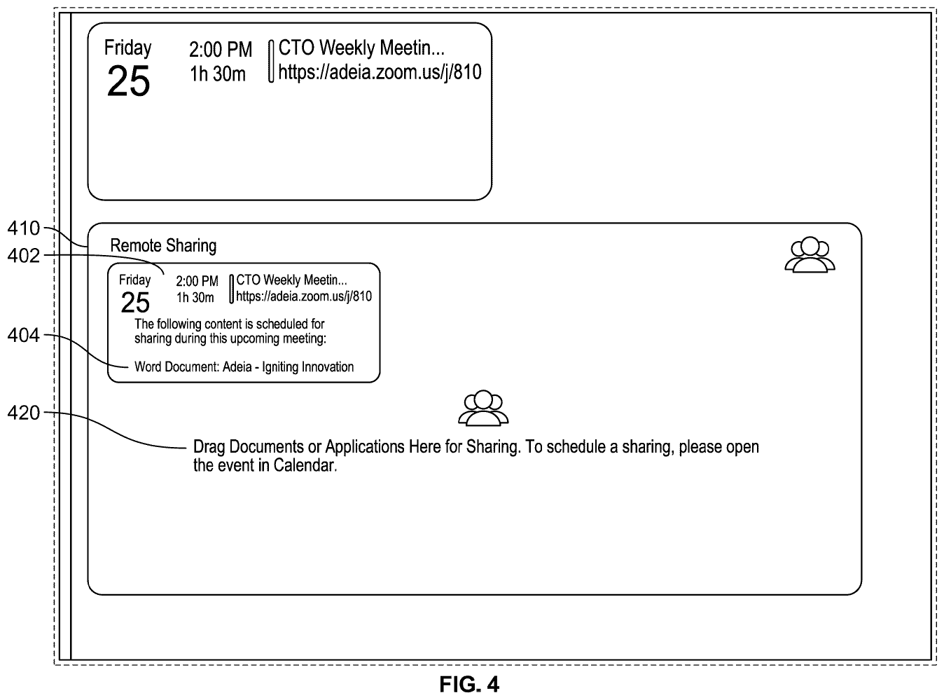

In some examples, once a particular document is uploaded to the cloud storage, a preview of the pre-shared content (such as but not limited to a thumbnail) is generated by the virtual meeting system to be used within the virtual meeting scheduling application or calendar application (e.g., within an Outlook calendar) to represent the shared document. In some examples, the preview may function as an anchor for accessing URLs or other “clickable” objects which may allow users to view the particular document. FIG. 2C illustrates a preview of particular document 204 as a thumbnail image. FIG. 4 illustrates a virtual meeting entry 402 within a calendar widget 410, wherein a preview 404 of the particular document shared for the virtual meeting is shown as a text entry. Rather than illustrating the shared document as an image 204 as in FIG. 2C, in some examples the particular document may be listed by its title or other identifying information and previewed as a text entry 404. FIG. 4 also illustrates a prompt 420 within the widget 410 that informs the user that particular documents may be dragged into the widget for sharing with respect to the virtual meeting 402.

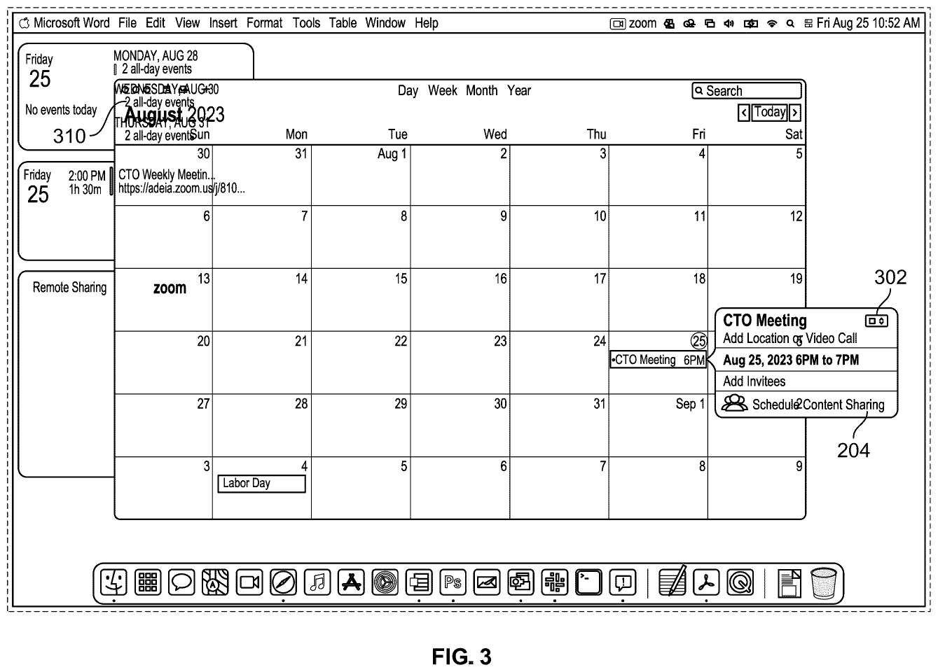

FIG. 3 illustrates a user interface of a calendar application 310 indicating that materials may be shared for an upcoming event. That is, when a user schedules the virtual meeting 302, the calendar application may include a prompt 306 indicating that the user may add a particular document to be shared during the virtual meeting. If the user does add a particular document, the particular document may be uploaded to the shared storage as discussed elsewhere in this disclosure.

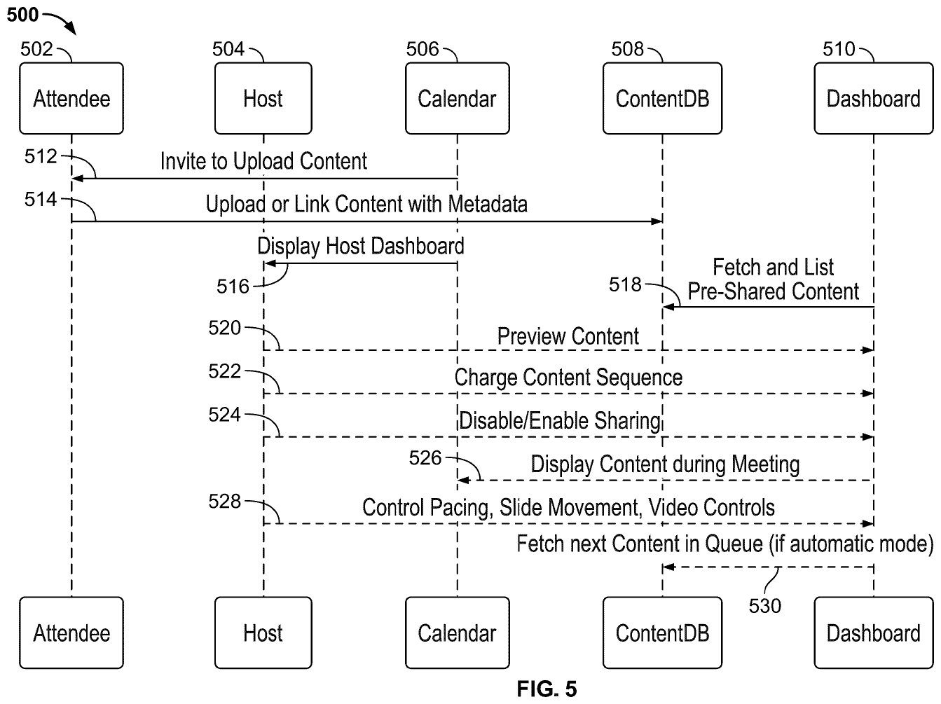

FIG. 5 depicts an illustrative sequence diagram 500 for how a user may schedule a virtual meeting and add particular documents to be presented during the virtual meeting. In some embodiments, the virtual meeting system may enable the meeting host to oversee and manage the presentation of pre-shared content, even when the content's original sharer might not have yet joined the virtual meeting or cannot actively manage the presentation of the content during the virtual meeting. When a virtual meeting is being set up through the event scheduling system (e.g., as described above), the meeting scheduler and meeting invitees may be prompted to upload or link any content they intend to share during the virtual meeting. Each piece of content may be tagged with metadata that includes the owner's identification, access permissions, etc.

Sequence diagram 500 illustrates steps performed by an attendee 502, a host 504, the calendar application 506, a content database 508 (e.g., cloud storage), and a dashboard 510. At step 512 and 514, the attendee 502 is invited to upload content to be shared at the virtual meeting, and then uploads the content with associated metadata to the content database 508.

At 516, the dashboard 510 is displayed to the host 504. And at step 516, the dashboard retrieves information from the content database 508 regarding the pre-shared content. In some examples, the host 504 is provided with a dashboard 510 which includes a list of all the pre-shared content for one or more virtual meetings. The dashboard may categorize the pre-shared content by, for example, the user who shared the content, the file creation time, and the file type. The dashboard 510 may offer a real-time view of all the content that is queued for sharing during the virtual meeting. The dashboard also enables the host to perform various functions such as previewing content, changing the content sequence, or even temporarily disabling sharing of the content.

At steps 520, 522, and 524, the host 504 may perform various functions related to the pre-shared content through the dashboard 510, such as previewing the content, changing the content sequence, and disabling/enabling sharing of the content. The host 504 may change the order of presentation of sections within a particular document, as well as changing the order of presentation of particular documents when there are two or more documents to be shared during the virtual meeting.

In some examples, the host 504 may be permitted to control the presentation of the pre-shared documents during the virtual meeting. This enables the host 594 to display any participant's pre-shared content, ensuring smooth flow and continuity of the virtual meeting including in circumstances where a participant might be unable to present their content.

At step 526, the sequence 500 includes displaying the content during the virtual meeting. The dashboard may access the content from the content database 508, and then cause the particular document to be displayed on each participant's device. And at step 528, the sequence 500 may include the host 504 controlling presentation of the content by controlling the pacing, slide movement, video controls, etc. Enabling the host to control presentation of the pre-shared content may be beneficial in a situation where an attendee 502 who pre-shared content has not joined the virtual meeting or cannot manage their content. In this case, the host 504 can use the dashboard 510 to initiate the display of that content. Further, to ensure smooth transitions, the virtual meeting system can be set to an automatic mode where, as in step 530, after presentation of one content piece ends, the next content piece in the queue is automatically displayed. The host 504 may retain the authority to intervene, if necessary. For content types that are interactive (e.g., a slideshow or a video), the host 504 may control the pacing, moving to the next slide, rewinding, or forwarding videos, or pausing the presentation.

While in some examples the host 504 may have the authority to display any pre-shared content, the host 504 may be prevented from editing or altering the original content. This ensures that the integrity of the content is maintained, and only the content owner can make modifications. When the virtual meeting has completed, the host 504 may have the option to archive the sequence in which content was displayed, which can be helpful for future reference or for attendees who might want to revisit the session. Archiving may include recording, summarizing, capturing and compiling screenshots, and/or any other actions take with respect to the presentation of the documents.

It should be appreciated that while the functions noted above and shown in FIG. 5 are described with respect to the host 504, in some examples an attendee 502, document author, presenter, other party may also access the dashboard 510 and carry out the same functions. That is, in some examples one or more of the attendees, authors, presenters, or other parties may preview the particular documents to be shared during a virtual meeting, change the sequence or order of presentation of particular documents and within a given document (e.g., modifying content within the document), disable/enable sharing of one or more particular documents, control pacing, slide movement, and video controls, etc.

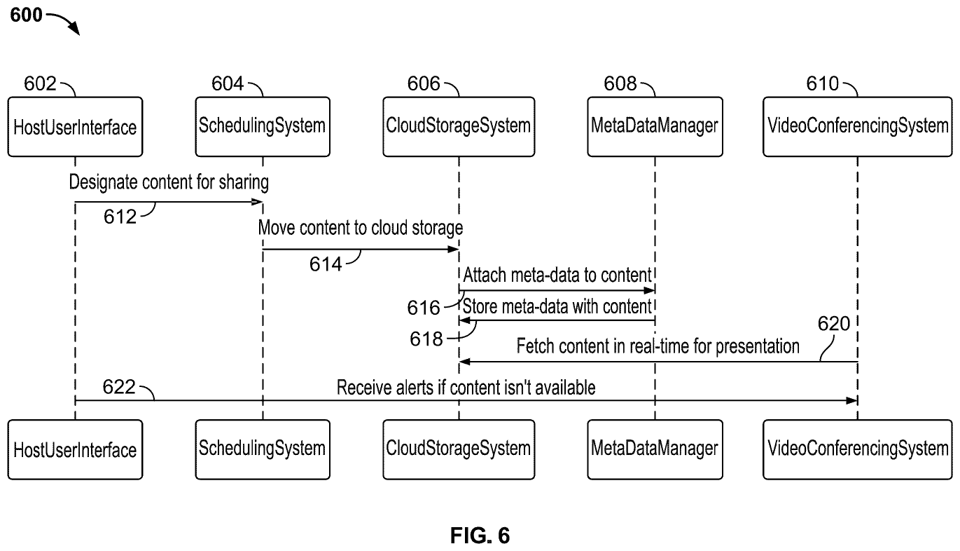

FIG. 6 depicts an illustrative sequence diagram 600 for how particular documents or other materials may be added to the shared storage, and then accessed for presentation during a virtual meeting. In some embodiments, when an attendee or host 602 schedules a virtual meeting through the scheduling system 604 and designates content for sharing, this content is moved to the cloud storage system 606. The cloud storage 606 may be any suitable shared or private storage, such as storage from a service like Amazon Web Service (AWS S3), Google Cloud Storage, or any other platform. Each piece of content stored in the cloud storage 606 may be enveloped with metadata. The metadata may include details like the owner identification, the time of upload, intended display time, expiration time, and unique session or meeting ID. Only those with the correct permissions (e.g., attendees of the virtual meeting) may be permitted to access the content in the cloud storage, and only within the stipulated time frame. This minimizes the risks of content being accessed outside of its intended presentation window.

At step 612, the virtual meeting host designates content for sharing during the virtual meeting. And at step 614, the content is moved to the cloud storage 606. At steps 616 and 618, the cloud storage 606 and metadata manager 608 operate to attach the appropriate metadata to the content uploaded to the cloud storage 606, and store that metadata along with the particular document in the cloud storage. This may include the various metadata information such as the document owner, time of upload, intended display time, expiration time, unique session or meeting ID, etc.

When the virtual meeting begins, and it is time to present the content stored in the cloud storage to the participants of the virtual meeting, step 620 includes the video conferencing system 610 retrieving the content from the cloud storage 606 in real-time for presentation. This ensures that there is limited lag or delay during presentation of the content. If, for some reason, the particular document is not available in the cloud storage or some other error occurs, step 622 includes the host or other participants of the virtual meeting receiving an alert indicating that the content is not available.

In some examples, the storage of the content in the cloud storage is temporary, and the accessibility parameters (e.g., who can access the particular document and when) may be defined by the virtual meeting's temporal markers. After a predetermined time post-meeting, the virtual meeting system can take one of several actions. Those actions may include automatically deleting the content, and/or moving the content to a more permanent storage location if archival is needed. If the content remains in the cloud storage, the visibility parameters may be changed to restrict access, prevent further access, and/or add additional access. For example, permissions may be removed from one or more parties (e.g., meeting attendees), and/or granted to one or more parties including those who were not participants in the virtual meeting(s).

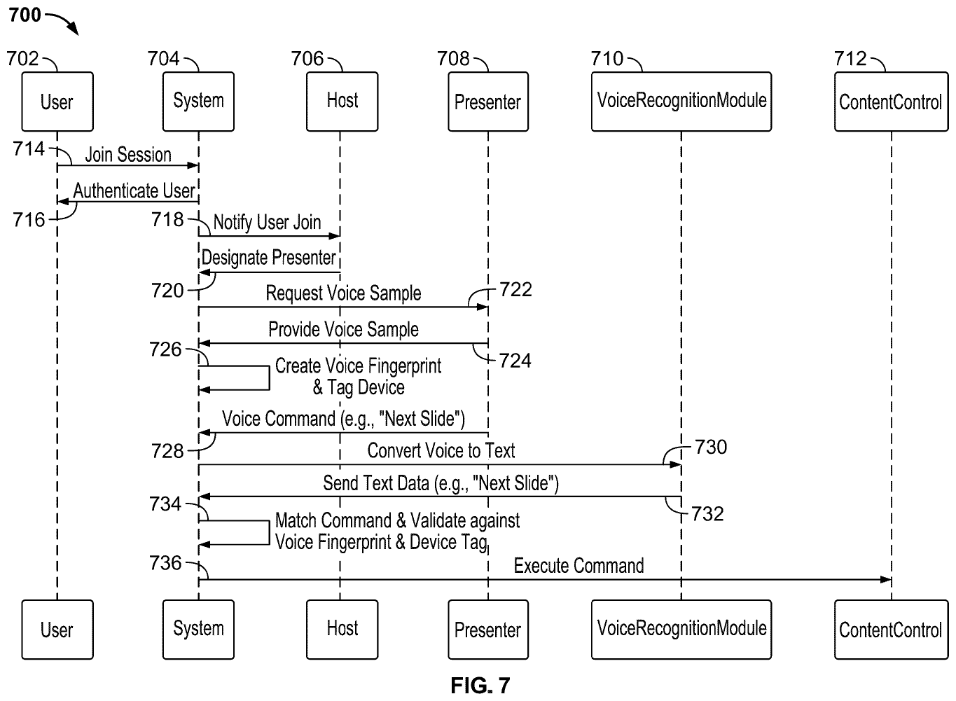

FIG. 7 illustrates a sequence diagram 700 showing how a presenter may use their voice to control presentation of content during a virtual meeting. This may be useful for presenters that are not able to control presentation easily via a computer, such as presenters that are on the go, in a vehicle, on the phone, or otherwise not in front of a computer. In addition, the voice control technique described herein may be useful in situations where the presenter and other participants all speak. The system described herein may discount or ignore voice commands received from users other than the designated presenter. In some examples, the virtual meeting system may include a voice recognition module 710 used in combination with device authentication to ensure an efficient and secure hands-free management of pre-shared content during a virtual meeting. The virtual meeting system may process incoming audio signals, convert them into text data, and then match against specific predefined commands stored in the system. Common command templates may be, for example, “Next Slide,” “Previous Slide,” “Pause Presentation,” and the like.

At step 714, a user 702 joins the virtual meeting hosted by the system 704. The system 704 then authenticates the user 702 at step 716. After authentication, the user is then recognized by the system. Additionally, along with authenticating the user, the system 704 may acknowledge and log the specific device from which the user 702 has joined.

At step 718, the system notifies the host 706 that the user has joined the virtual meeting. The host then has the option to designate the user 702 as a presenter 708 at step 720. The host 706 may retain the authority to designate a presenter from among the attendees of the virtual meeting. Upon this designation, the system may activate a number of checks or processes to be able to execute the voice control functionality. The checks may include voice command recognition for a specific user that has been designated as the presenter, and device authentication for the device of the user designated as the presenter. The user designated as presenter 708 may be presented with a request for voice recognition permission.

At step 722 and 724, the system 704 requests a voice sample from the presenter 708, and the presenter 708 provides the voice sample to the system 704. This may include the system requesting that the presenter speak a predetermine set of words, which may then be analyzed and used to create a voice fingerprint for that presenter.

At step 726, the system creates a voice fingerprint for the presenter 708, and tags the device used by the presenter 708. This enables the system to identify where incoming voice commands are coming from, and to decide whether to act on the incoming voice commands based on their source.

At step 728, during the virtual meeting when a particular document is being presented, the presenter 708 may speak a voice command (e.g., “Next Slide”). The presenter's audio may be received by the system 704, and converted into text at step 730 by the voice recognition module 710. The voice recognition module 710 may include advanced neural networks and digital signal processing algorithms, configured to tune in to the presenter's voice commands and convert them into text.

At step 732, the voice recognition module 710 transmits the text data to the system 704. And at step 734, the system 704 matches the text data to one of a list of commands which are available. For example, the system 704 may include a predetermined list of possible commands which are available for controlling presentation of documents via speech. The system 704 may then compare the received text data from the voice recognition module 710 to determine whether one of the commands has been input by the presenter.

At step 736, if a command has been received and a match is confirmed, the system 704 may execute the command by controlling presentation of the particular document via the content control 712 based on the input command.

In some examples, rather than using voice recognition to identify a command received from the designated presenter, the system may use device authentication to determine the source of a control command. For instance, the system 704 may generically listen for keywords (e.g., next slide, pause, and/or other terms) which have been input into the system from all users. When the system 704 detects a given keyword that matches a predetermined set of control keywords, the system 704 may determine from which device the keyword was input. The system 704 may then match the associated user from that determined device with the presenter designation. If the keyword was input from the presenter's device, the system 704 may then execute the appropriate command using content control 712. When the host 706 designates a presenter 708, instead of or in addition to capturing a brief voice sample to establish a voice fingerprint for that user, the system may tag the specific device being used by the presenter.

In some examples, both voice recognition and device authentication may be used. Any voice command initiated for content control may be double-checked: first, by validating the input voice sample against the voice fingerprint and secondly, by confirming that the input voice sample was received from the presenter's device.

It should be appreciated that while the example shown in FIG. 7 pertains to a single presenter, other examples may include multiple presenters, and/or the host or one or more other parties may also have the ability to use voice control. That is, while the example described with respect to FIG. 7 includes receiving voice samples and inputs from the presenter via the presenter's device, other examples may include enabling the host or other parties to perform voice control. In these cases, each party for whom voice control is enabled may provide a voice sample and device tag such that the system 704 may determine a voice fingerprint, and/or confirm the device from which the voice command inputs were received.

Additionally, while the example shown in FIG. 7 pertains to voice control, the features described may be performed using a user interface (e.g., as part of a phone application), to control presentation using such as by using a set of buttons to show pre-shared content, next slide, previous slide, scroll down, etc.

Furthermore, in some examples multiple documents may be shared or presented during a meeting. The virtual meeting system may identify a transition from presentation of a first document to presentation of a second document. The virtual meeting system may also, based on the identified transition between documents, differentiate recordings of audio and video of the meeting for each presented document. As discussed elsewhere in this disclosure, the audio, video, and other commentary may be recorded and associated with each document that is presented. When the virtual meeting system transitions from a first document to a second document, that may trigger a tag in the recording, may stop the recording and start a new recording, or may otherwise be used to differentiate between the commentary associated with each document. In some examples, the transition in presentation of a first document to a second document may include changing the window focus between the first and second document, thereby changing which document is currently selected by the presenter. Furthermore, it should be appreciated that the voice control and/or user interface control of the presentation of documents, described herein, may also be used to control transitioning from presentation of one document to another.

In some examples, the virtual meeting system may fail to confirm that a voice command is received from the presenter or other party authorized to control presentation of the particular document during the virtual meeting. In this case, after confirming that the received voice command is not a match with the authorized user, and/or that the received voice command is not received from the computing device of the authorized user, the virtual meeting system may simply discard the received voice command. Additionally or alternatively, when a voice command is received but cannot be attributed to an authorized user or to an authorized computing device, the virtual meeting system may prompt one or more participant (e.g., the presenter or host) to allow the voice command to be carried out, and/or to grant presentation control to the user or device that input the voice command. In further examples, when a voice command is received but cannot be attributed to an authorized user or computing device, the virtual meeting system may simply display an alert indicating that a voice command was received but not executed, enabling the presenter or host to take a suitable action in response.

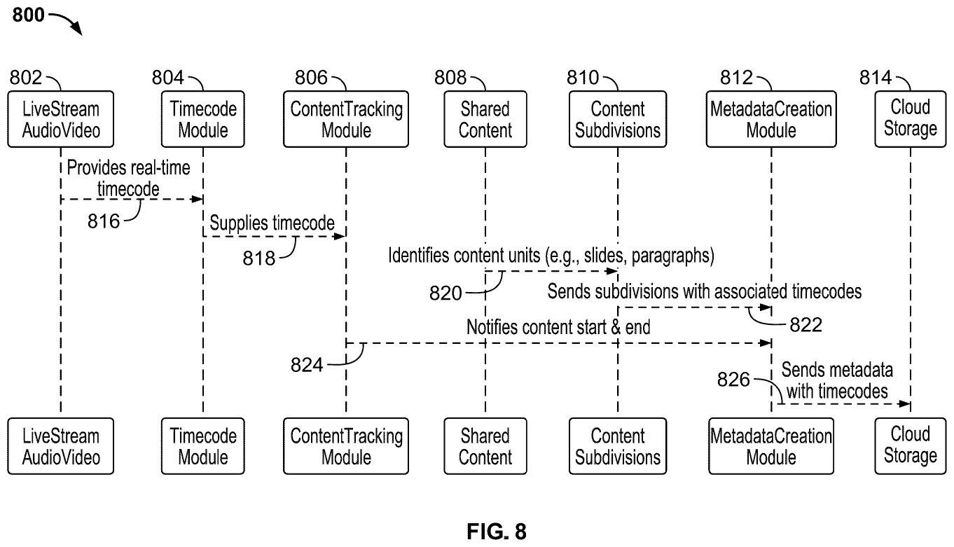

FIG. 8 illustrates a sequence diagram 800 for receiving and storing commentary and metadata related to the presentation of materials during a virtual meeting. In some examples, metadata is created during the virtual describing a detailed mapping of specific time intervals from the virtual meeting's subtitles, audio, and/or video to the corresponding content being presented. This may enable users to efficiently locate and reference portions of the virtual meeting from within the presented documents based on content markers. That is, commentary from the participants of the virtual meeting, including text comments, audio, and video, may be segmented and linked to the shared document itself. After the virtual meeting concludes, a user may access the shared document to view the text, audio, and video that corresponds to the particular portions of the particular document that was shared during the virtual meeting. For example, if the virtual meeting includes a discussion of page one of the shared document during minutes 10-13, and 16-18, when a user later reviews page one of the shared document there may be links or other user interface elements corresponding to minutes 10-13 and 16-18 of the virtual meeting. The user may click on one of these elements within the shared document, and may view the video of the virtual meeting that occurred between minutes 10-13 and 16-18.

As the live stream event progresses, the system actively tracks when each piece of content is introduced into the presentation. For example, the system may identify and store time stamps associated with when a slide is projected, a particular document is opened, or a video is played. Each initiation action may correspond to a specific timecode from the ongoing live stream of the virtual meeting. Within the shared content, the system may further identify subdivisions. For instance, within a particular document, the system may recognize individual pages, paragraphs, chapters, or other subdivisions. In a slide deck, the system may identify slide transitions, animations, or other interactions with the slide (e.g., display next bullet point). For videos, the system may identify scene changes or other significant moments. Each subdivision of the shared content may then be associated with the specific initiation and termination timecodes from the live stream. In some examples, the virtual meeting system may pre-process the document before the virtual meeting takes place. For example, the virtual meeting system may prepare the document for annotation by using a large language model to summarize or identify keywords for portions of a document, to facilitate real-time association of commentary with the paragraphs. Other pre-processing techniques for documents may be used as well.

Based on the tracked associations between the portions of the shared content and the live stream itself, the virtual meeting system may create metadata entries. Each metadata entry may include the content identifier (e.g., slide title, document name, video title), the subdivision identifier (e.g., slide number, page number, paragraph number, scene marker), and the corresponding timecode intervals from the live stream. The created metadata entries may then be embedded within the shared content file itself, and/or stored alongside the shared content file in the cloud storage. When a user accesses the shared content after the virtual meeting concludes, the user will be able to access the accompanying timecode markers from the virtual meeting itself, in some cases by clicking on or hovering over these markers in the shared document. The markers may provide details like the exact moment in the live stream's audio or video when the content or its subdivision was presented. Users can then quickly jump to these points within the virtual meeting recording, making content review or follow-up discussions more efficient.

In sequence 800, the virtual meeting system may include a livestream of the virtual meeting 802 (e.g., audio, video, or both), a timecode module 804, a content tracking module 806, the shared content 808, content subdivisions 810, a metadata creation module 812, and a cloud storage 814. At step 816, the live stream is supplied to the timecode module 804. The timecode module 804 analyzes the live stream to identify the timecodes of the beginning and ending of presentation of each portion of the shared content. For example, when a particular document is opened, when a page is turned, when a slide is turned, etc.

At step 818, these timecodes are transmitted to the content tracking module 806. At step 820, the shared content 808 is subdivided into the content units (e.g., slides, pages, paragraphs, etc.), and at step 822 these subdivided units are sent to the metadata creation module 812.

At step 824, the content tracking module 806 notifies the metadata creation module 812 of the timecodes associated with the beginning and end of presentation of each subdivision of the shared content. Then at step 826, the metadata creation module 812 transmits the metadata and timecodes to the cloud storage 814.

After the virtual meeting concludes, the system may possess a complete recording of the audio and video of the virtual meeting, as well as timeline metadata associated with each subdivision of the shared content. Using this timeline metadata, the system may segment the recording of the virtual meeting in to portions or smaller chunks. Each portion may correspond to a specific piece of the shared content, and/or to a significant event in the virtual meeting. For example, if a PowerPoint slide was presented for 5 minutes 12 seconds, the system may create a 5 minute 12 second audio/video segment corresponding to that slide. By segmenting the virtual meeting recording into subdivisions tied directly to the portion of the particular documents presented during the virtual meeting, the system may create an organized recap of the virtual meeting that is tied to and organized based on the particular document itself. Rather than presenting a chronological recap based on the discussion during the virtual meeting, the system may create a recap of the virtual meeting organized based on the structure and order of the particular document itself. That is, if the virtual meeting discussed portions of the particular document out of order (e.g., page 3, then page 1, then page 6, then page 10, etc.), the system may create an organized recap wherein portions of the virtual meeting recording are cropped out and presented to the user in order of the particular document itself. The discussion of page 1, 3, 6, then 10 may be presented to the user, even though the timecodes for the discussions of these portions are not in chronological order. When, after the virtual meeting concludes, a user opens the shared document, a link to the discussion of page 1 may be presented alongside page 1, a link to the discussion of page 3 may be presented alongside page 3, and so on. Additionally, if a presenter discusses the same page at two or more different points during the meeting (e.g., discussing page 1, then page 3, then back to page 1), the full discussion of page 1 (including both the first and second distinct portions of commentary) may be presented to a user when reviewing page 1. The virtual meeting system may cut and/or edit the meeting audio and commentary for each portion of the document, so that all the audio and commentary relevant to each portion of the document is presented to the user. In the example noted above, this may include cutting out the discussion of page 3, and playing the two portions of audio from the discussion of page 1. Furthermore, the virtual meeting system may enable a user to use the audio and/or commentary from a meeting to control their review of the document. The virtual meeting system may play the audio from a meeting, and automatically change which portion of the document is displayed based on the commentary and/or actions of the presenter during the meeting. Still further, as discussed elsewhere, the virtual meeting system may enable a user to navigate through the document by reviewing the commentary. That is, the user may select portions of commentary, and automatically navigate to the relevant portion of the document.

In some examples, the segmentation of the shared content can be finer and allow for more granularity. For example, if the shared content is a PowerPoint presentation wherein one slide contains two figures, the system may detect through monitoring the presenter's cursor (or based on analysis of the audio during presentation of the slide) that the discussion during the virtual meeting during a first time period is associated with a first figure on the slide, and the discussion during the virtual meeting during a second time period is associated with a second figured on the slide. In this case, the system may associate the discussion during the first time period with the first figure and the discussion during the second time period with the second figure. Similarly, if a slide is made of different animations, the audio/video commentary captured during the presentation of that slide may be further divided into portions associated with different elements of the animation.

In some examples, the virtual meeting system may be configured to detect significant changes during the presentation of shared content, such as moving from one slide to another, scrolling to a next page, etc. In this case, the recorded audio and/or video of the virtual meeting can be segmented further based on these subdivisions.

In some examples, the segmented recording of the virtual meeting may be made available as soon as it is segmented, thereby enabling a user who has joined the virtual meeting late to catch up by browsing through the shared content. That is, the late-joining user may scroll through the shared document, and see which portions have been discussed or not (as well as viewing/listening to the corresponding discussion). The recorded audio and/or video segments may remain with the shared document as links or as embedded content within an “event or meeting feedback” tool.

In some examples, the virtual meeting system may create bookmarks with media timecodes with embedded metadata in the shared document. These timecodes may be references to the timecodes in the virtual meeting on a document per page basis. When the shared document is opened and the user scrolls through the pages of the shared document, the audio and/or video may be played from the virtual meeting corresponding to that page of the shared document.

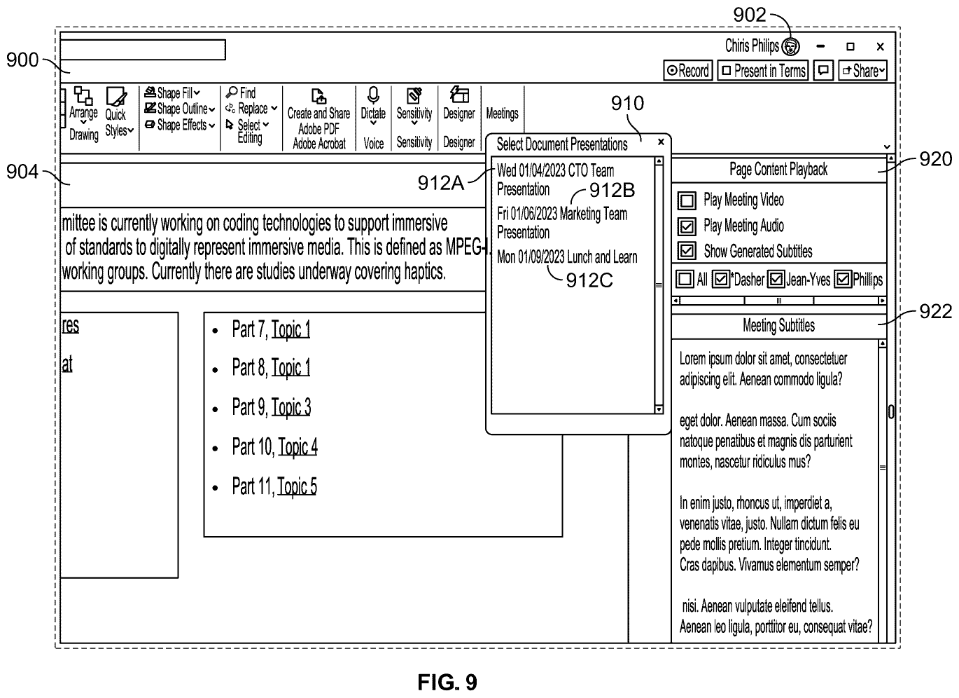

FIG. 9 illustrates an example user interface according to embodiments of this disclosure. The user interface 900 illustrates how a user 902, after the conclusion of multiple virtual meetings in which a particular document was presented, may select commentary from one of the multiple virtual meetings for review. As noted above, after a virtual meeting concludes, the communication data (e.g., text, audio, and video commentary associated with the virtual meeting) may be stored in the cloud storage and associated with the shared document (e.g., embedded within the shared document). The participants in the virtual meeting may then access the communication data associated with the presentation of the particular document by accessing the particular document in its native application.

For example, FIG. 9 illustrates a slide of a PowerPoint presentation 904 that was presented during several virtual meetings. In this example, the user 902 was a participant in each of the three virtual meetings in which the PowerPoint presentation 904 was presented. The user interface 900 includes a user selectable interface element 910 that lists the virtual meetings 912A, 912B, and 912C in which the PowerPoint presentation was presented, and in which the user 902 was a participant or has otherwise been granted access. In this example, the user 902 selected the first virtual meeting 912A. The user interface 900 may also include an options menu 920 that enables the user 902 to select whether to view the virtual meeting communication data including video, audio, and/or subtitles. In the illustrated example, the user 902 has selected to play the virtual meeting audio and view the virtual meeting transcript 922. The user 902 may elect to change the content presented at any time when viewing the PowerPoint presentation 904, by selecting or deselecting any of the options in the options menu 920.

In some examples, the user interface 900 may provide more granularity. For instance, the user 902 may be able to select one or more virtual meeting participants to focus on, and only those selected participants' comments may be presented. In another example, when the user 902 moves through the particular document 904 (e.g., switches from slide to slide), only the commentary from virtual meeting participants who spoke or commented during presentation of the currently displayed slide (or currently displayed portion of the particular document) may be included. If a virtual meeting participant speaks during the virtual meeting during presentation of a particular slide (or portion of the shared document), that virtual meeting participant's audio recorded from the virtual meeting may be available for the user 902 to review. In some examples, each virtual meeting participant's audio may be separately recorded, enabling selective inclusion of the audio from only those participants who spoke or commented with respect to a given portion of the particular document. In other examples, the audio from all participants may be recorded as a single audio stream.

As shown in FIG. 9, the relevant transcript 922 from the currently displayed portion of the particular document 904 may be presented to the user 902. As the user 904 scroll through the particular document (e.g., advances to the next slide), the subtitles may be automatically updated to maintain relevance to the currently displayed portion of the particular document. In other examples, as the user moves the cursor through the particular document 904, the relevant subtitles or other virtual meeting communication data may be highlighted or otherwise emphasized. For example, if during the virtual meeting there were two separate discussions about different portions of the same page of the particular document 904, such as a first discussion regarding “Part 7, Topic 1” and a second discussion regarding “Part 8, Topic 1,” different subtitles or virtual meeting commentary may be emphasized depending on whether the user 902 hover's their cursor over the text “Part 7, Topic 1” or “Part 8, Topic 1.”

It should be appreciated that FIG. 9 shows the example document as a PowerPoint presentation 904. However, in other examples the document may be a Word file, a video, or any other suitable sharable file. The same features and functionality described above may also apply to those other sharable files. In addition, FIG. 9 illustrates that the user interface element 910 enabling the user 902 to select one of the three virtual meetings 912A, 912B, and 912C is presented while the user is viewing a slide of the particular document 904. However, in some examples the user 902 may be presented with the option to select a virtual meeting corresponding to the particular document upon startup of the corresponding application (i.e., upon opening the PowerPoint Application), upon opening the particular document itself (i.e., upon opening the presentation 904), and/or by selecting an option in the application menu (e.g., by selecting “File”-->“Virtual Meetings”). Various other methods for selecting and displaying the option to view the communication data for one or more virtual meetings in which a particular document was presented may also be used.

In some examples, the user interface element 910 may also display virtual meetings scheduled in the future in which the particular document is expected to be presented. In this case, there may not be associated communication data to be displayed. This may allow the user 902 to view, from the same user interface element, whether there are any upcoming virtual meetings in which the particular document will be discussed in addition to previous virtual meetings in which the particular document was already discussed. In some examples, the user interface element 910 may also display one or more meetings a user was not invited to, but for which the document was shared anyway, such as by selecting the saved meetings the document was presented in. For instance, the virtual meeting system may enable the presenter of a document, when sharing the document, to be given an option to select the meetings the document was presented in. When the user to whom the document has been shared opens the document, the meetings the document was shared in may be options for the user to select. When the user selects a given meeting, that presentation audio and associated data will be presented to the user.

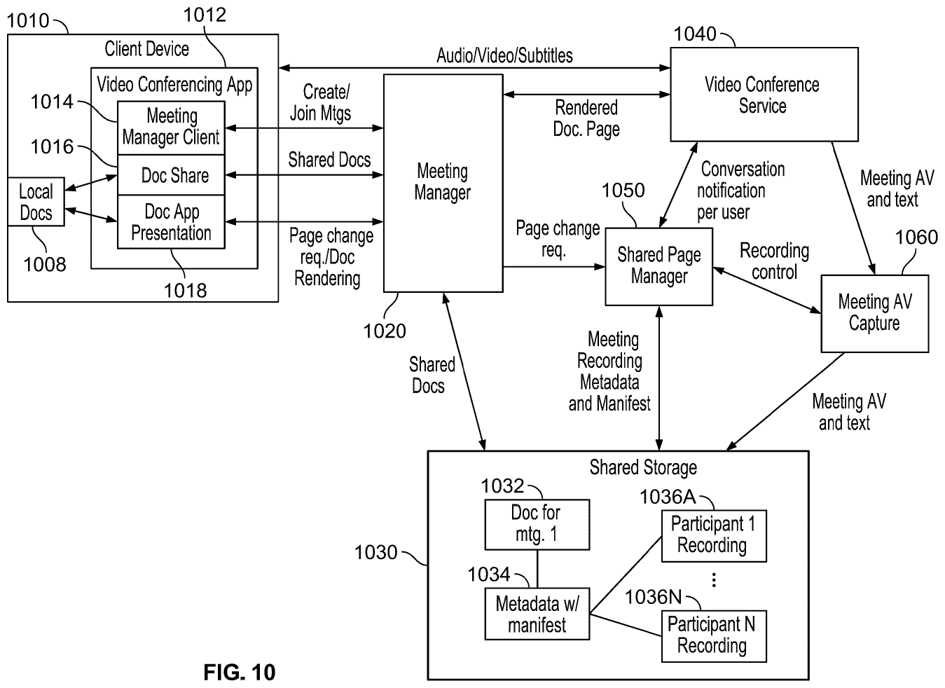

FIG. 10 depicts a simplified block diagram illustrating parts of a system architecture showing various interfaces for a meeting presenter to pre-share a particular document to the shared storage, and/or present the particular document while the virtual meeting is in progress. In some examples, a presenter using client device 1010 may pre-share a particular document from their local storage 1008. During the virtual meeting, all meeting attendees' video and audio session streams will be recorded for the session and recorded as adaptive bit rate (ABR) video. In some examples, there may be a single recording including all meeting participants, while in other examples there may be a separate recording for each participant. These may be recorded at ABR separate adaptation sets. These streams may be encrypted and stored in a shared folder in the shared storage 1030 accessible by all meeting invites.

In some examples, anytime the presenter changes pages of the shared document during the presentation, the timecode of when the change was made is determined and stored. A manifest for each page in the shared document is created, in some cases on a per user basis. If a given user does not speak during the presentation of a page of the shared document, there will be no manifest for that user in the metadata attached to the shared document in the shared storage 1030. Each page of the shared document will have media timecodes associated with it, based on the beginning and ending times at which the page was presented during the virtual meeting. When the virtual meeting is complete, the generated metadata will include the attendees' names or other identification, and URLs to the manifests which are generated on a per user and per page basis with respect to the shared document. Therefore, after the virtual meeting concludes, the shared storage includes a manifest for each user which includes the virtual meeting communication data (e.g., video, audio, and text) represented as separate adaption sets for when that user spoke in the virtual meeting. Formatting the manifests in this manner allows selection of all users or any subset of users who spoke during the virtual meeting while a given page of the shared document was being presented.

As shown in FIG. 10, the architecture includes client device 1010, which includes video conferencing application 1012 and a local document storage 1008. The video conferencing application 1012 also includes a meeting manager client 1014, a document share 1016, and a document application presentation 1018. The local document storage 1008 may share locally stored documents with the document share 1016 and the document application presentation 1018.

The architecture also includes a meeting manager 1020, which receives documents from the client device 1010, and enables the user of the client device 1010 to schedule and join virtual meetings. The meeting manager client 1016 may communicate with the meeting manager 1020 to share information relating to create meeting requests and responses, join meeting requests and responses, meeting IDs, shared document URLs, recording start and stop requests, and more. The document share 1016 may communicate with the meeting manager 1020 to share information relating to the particular documents to be shared, share document requests and responses, and more. The document application presentation 1018 may communicate with the meeting manager 1020 to share information related to document page change requests (e.g., user control of the presentation), embedded meeting recording metadata with manifest URLs, rendered document pages, and more.

The meeting manager 1020 may be configured to communicate with the shared storage 1030 to share the document(s) that are scheduled to be shared during a virtual meeting. The meeting manager 1020 may also be configured to communicate with the video conference service 1040 to share information regarding rendered document pages, for display to participants. The video conferencing service 1040 may also receive audio, video, and subtitles or text (e.g., virtual meeting communication data) from the client device 1010, as well as the other participants of the virtual meeting (not shown). The video conference service 1040 may also include video and audio processing circuitry configured to receive audio, video, and/or text from other participants to be multiplexed together, and to provide rendered document images, and multiplexed audio, video, and/or text to other participants.

The meeting manager 1020 may also communicate with the shared page manager 1050 to share information regarding document page change requests, and/or other presentation control inputs. The shared page manager 1050 may communicate with the shared storage 1030 to share information regarding recording manifests, embedded meeting recording metadata updates with manifests, and more. The shared page manager 1050 may also communicate with the video conference service 1040 to share information regarding conversation notifications, which may be done on a per user basis. Further, the shared page manager may communicate with the meeting av capture 1060 to share information regarding recording start and stop requests by one or more users, recorded meeting timecode requests and responses, and more.

The meeting av capture 1060 may communicate with the shared storage 1030 (via an encryption system (not shown), to share information regarding audio, video, and text streams from participants (with manifests per user), encryption keys, and more. The meeting av capture 1060 may also communicate with the video conference service 1040 to share information regarding encoded video, audio, and text from participants of the virtual meeting.

The shared storage 1030 includes the particular document 1032 presented during the virtual meeting, as well as the associated metadata and manifest 1034 indicating which portions of the audio, video, and/or text of the virtual meeting are associated with various portions of the shared document. The shared storage 1030 also includes a recording of each participant (and/or a combined recording of all participants) during the virtual meeting, shown as recording s 1036A-N.

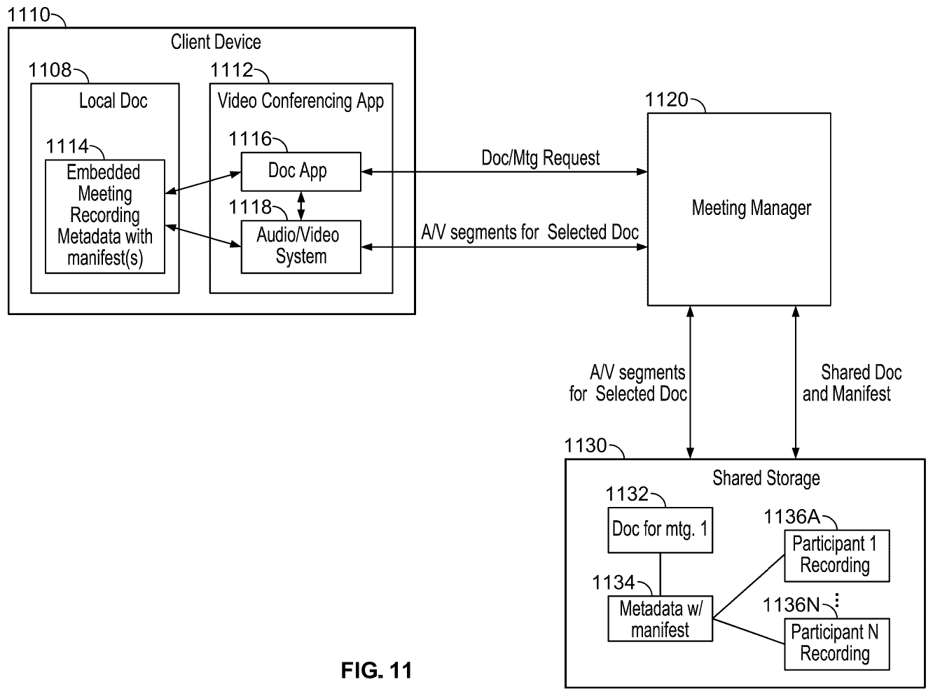

FIG. 11 illustrates a simplified block diagram of an example system architecture for a user to view a particular document presented during a virtual meeting, and select within the particular document whether to present commentary on a per user basis. This may occur after the virtual meeting has concluded, and the user wishes to review the discussion that occurred regarding the particular document during the virtual meeting (whether or not the user was a participant in the virtual meeting itself).

As noted above, there may be an ABR separate adaptation set manifest per user, per page of the shared document, which also includes subtitles, text, and/or a transcript of the audio that occurred during the virtual meeting. The user may access a particular document using the document application 1116, and specify which virtual meeting communication data or commentary, as well as from which participants within that virtual meeting, to retrieve with respect to the accessed document. The request may be sent to the meeting manager 1120 on a per page basis. Since the manifests with respect to the audio and video of the virtual meeting may be separate adaptation sets per user, the bandwidth used may be limited to only that needed for pulling the content from the shared storage 1130 based on the user's selection, which may include video, audio and/or subtitle or text data.

In the illustrated example of FIG. 11, when the user begins their attempt to access the shared document and the corresponding communication data from the virtual meeting in which that particular document was presented, the user may access the particular document via the local document 1108. The local document 1108 may be associated with a file including the embedded meeting recording metadata with manifests 1114, detailing when the pages of the particular document were presented, who spoke during the presentation of each page, etc. The video conference application 1112 may send a request to the meeting manager 1120 with the particular document identifier, meeting identifier, and/or requesting user identifier. The document application 1116 may also communicate with the audio/video system 1118 to share information regarding the subtitles, text, and/or transcript extracted from the manifest for them virtual meeting, regarding ABR manifest requests URLs for documents for user selection for a current page with audio, video, and text, and more.

The audio/video system 1118 may communicate with the meeting manager 1120 to share information regarding manifest requests and responses for the current page and for the selected user(s), audio and video segment requests and responses for the current page and for the selected user(s), decryption requests and responses, and more. The meeting manager 1120 may then communicate with the shared storage 1130 to share information regarding the shared document(s) for the virtual meeting, document page manifests based on the user selection, manifest requests and responses for the current page and for the selected user(s), audio and video segment requests and responses for the current page and for the selected user(s), decryption requests, and more. The shared storage 1130 may include a shared folder for the virtual meeting, including the shared document, and an embedded meeting recording metadata with manifests(s) 1134. The shared storage 1130 may also include the recordings of each participant 1136A-N of the virtual meeting.

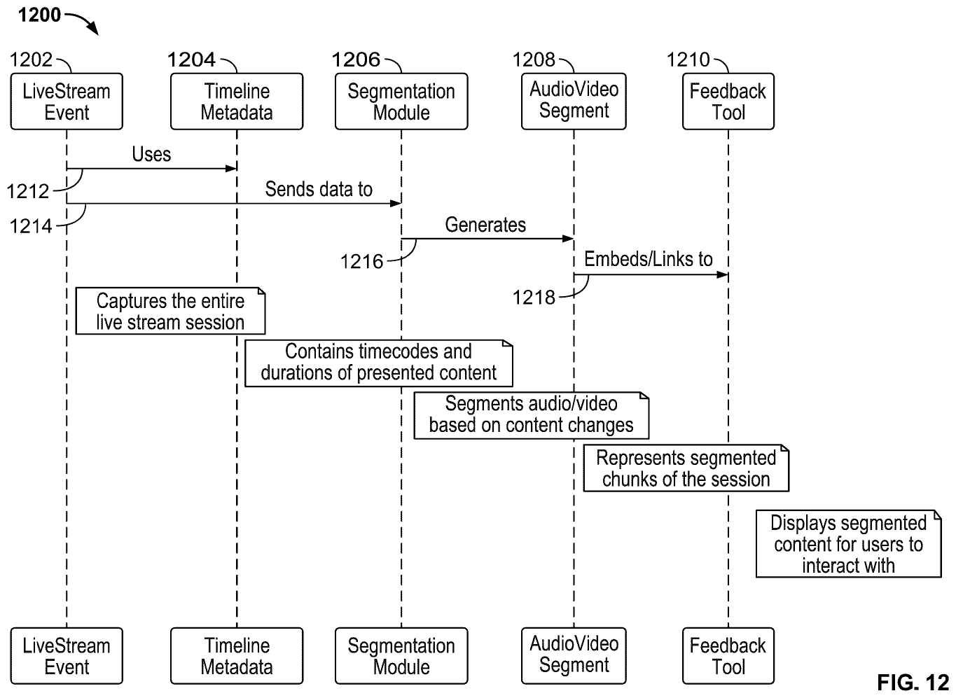

FIG. 12 depicts an illustrative sequence diagram 1200 for how virtual meeting communication data recorded during a virtual meeting, such as audio and video data, are segmented based on the presentation of a particular document during that virtual meeting. The virtual meeting system determines which pages or portions of a shared document are presented during the virtual meeting, as well as the timestamps of the beginning and ending of presentation of each portion. As noted above, it should be appreciated that the shared document presentation may be segmented into pages, paragraphs, slides, and/or any other suitable subdivision.

In order to segment the virtual meeting communication data of the virtual meeting based on the portions of the particular document presented during the virtual meeting, the sequence 1200 begins with the live stream event 1202 capturing the live stream session of the virtual meeting. The timeline metadata 1204 then indicates which timecodes apply to the portions of the shared document (e.g., the beginning and ending of presentation of each portion). Upon receiving these timecodes, the segmentation module 1206 segments the recording of the virtual meeting communication data of the live stream session based on the timecodes, creating segmented chunks of virtual meeting communication data segments 1208 that represent the audio and video recording that corresponds to each portion of the shared document. These segments are then embedded and/or linked to in the shared storage to enable users to access the segmented content when the shared document is later accessed. That is, the segmented communication data (i.e., audio and video from the virtual meeting) is stored in the shared storage, such that when a user later accesses the shared document and wishes to review the discussion with respect to a particular portion of the particular document, the virtual meeting communication data associated with a particular portion of the particular document can be retrieved from the shared storage using the feedback tool 1210.

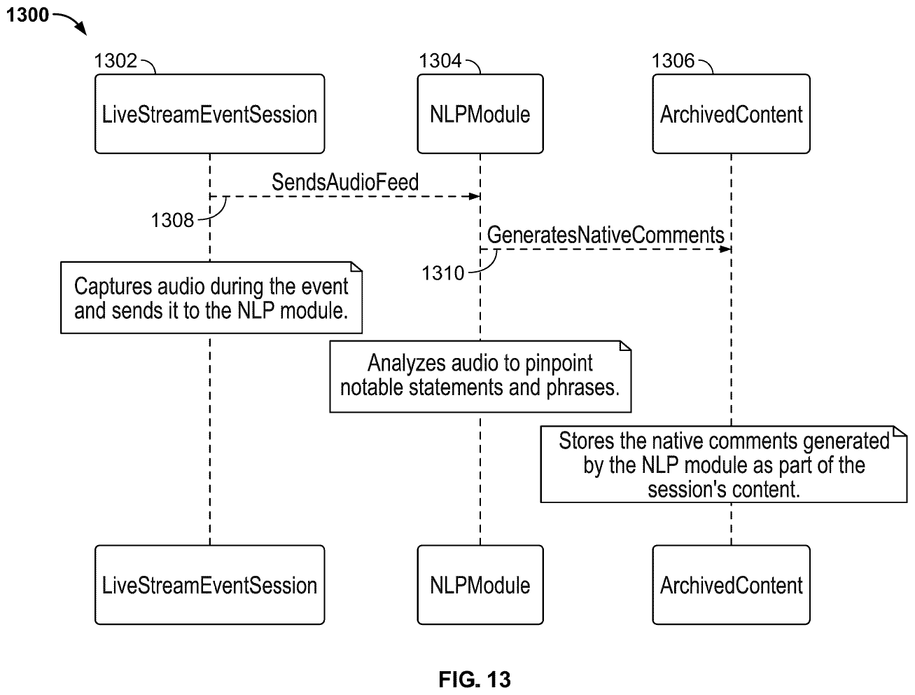

FIG. 13 depicts an illustrative sequence diagram 1300 showing how communication data received during a virtual meeting may be analyzed and stored as native comments (or processed metadata) and embedded within the presented document. In some examples, as the virtual meeting progresses, the virtual meeting system may continually capture the audio feed and process it using a natural language processing (NLP) module. This module may be designed to intelligently identify notable statements or phrases from the ongoing conversation. For example, phrases which may be considered editorial in nature such as, but not limited to, “I think we should change the color of this circle from red to blue” or “I think this is too wordy.” The virtual meeting system may leverage NLP techniques to understand the context of these phrases, identify significant remarks, and generate native comments automatically. These comments may include summaries of key points being discussed, clarifications of technical terms mentioned, and/or highlighting of crucial statements made during the event, for example.

In some embodiments, the NLP module may be configured to perform automatic speech recognition (ASR) to convert audio signals to a textual format, and/or to transcribe audio input to one or more participants' computing devices into a string of text using any suitable ASR technique. For example, one or more machine learning models may be employed, e.g., recurrent neural networks, bidirectional recurrent neural networks, LSTM-RNN models, encoder-decoder models, transformers, conditional random fields (CRF) models, and/or any other suitable model(s). In some embodiments, the NLP module may pre-process the received audio, e.g., to filter out background noise and/or normalize the signal. In some embodiments, the NLP module may include natural language understanding (NLU), e.g., tokenization of the string of the audio input, stemming and lemmatization techniques, parts of speech tagging, domain classification, intent classification and named entity recognition with respect to the received audio signals. In some embodiments, rule-based NLP techniques or algorithms may be employed to parse text included in the received audio signals. For example, NLP circuitry or other linguistic analysis circuitry may apply linguistic, sentiment, and grammar rules to tokenize words from a text string, and may perform chunking of the query, which may employ different techniques, e.g., N-gram extraction, skip gram, and/or edge gram; identify parts of speech (i.e., noun, verb, pronoun, preposition, adverb, adjective, conjunction, participle, article); perform named entity recognition; and identify phrases, sentences, proper nouns, or other linguistic features of the text string. In some embodiments, statistical natural language processing techniques may be employed. In some embodiments, a knowledge graph may be employed to discern relationships among entities. In some embodiments, one or more machine learning models may be utilized to categorize one or more intents of the audio input. In some embodiments, the NLP system may employ a slot-based filling pipeline technique and templates to discern an intent of captured audio signals. Additionally, large language models may be leveraged as well, such as for summarization and editorial change proposals.

As shown in FIG. 13, the sequence 1300 may include the live stream event session 1302 capturing the audio during the virtual meeting and sending it to the NLP module 1304 at step 1308. The virtual meeting system may also identify the source of the audio, including the identity of the speaker and/or the device from which the input was made. The NLP module 1304 then analyzes the audio to pinpoint notable statements and phrases. The NLP module 1304 then generates comments native to the application of the particular document being presented during the virtual meeting based on the notable statements and phrases at step 1310, and stores those comments as part of the virtual meeting's associated content in the shared storage or archived content 1306.

The NLP module 1304 may be configured to focus on various aspects of the audio according to the nature of the event or virtual meeting, or the preferences of the host or the attendees. For example, in a corporate setting, the NLP module may focus on picking out action items or deadlines mentioned, while in an educational setup, the NLP module may focus on extracting key learning points or resources mentioned. When the event or virtual meeting has ended, the generated native comments may form a part of the archived content material, serving as a quick reference guide a review of the event or virtual meeting's content.

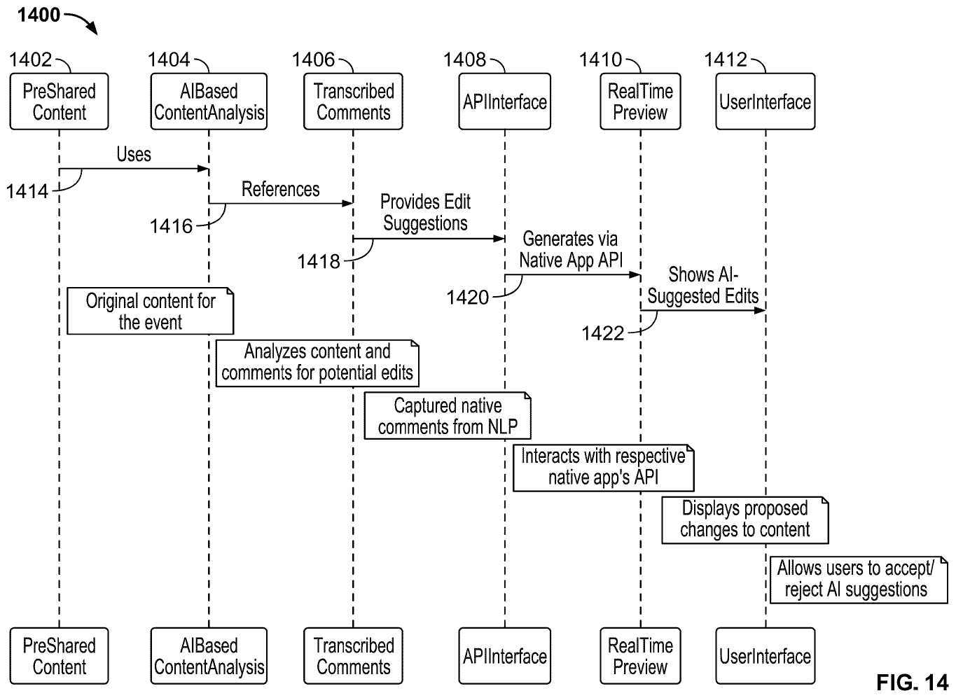

FIG. 14 depicts an illustrative sequence diagram 1400 showing how suggested edits to a presented document may be identified from the virtual meeting communication data including audio, video, and/or text, and presented to a user for review. As noted above with respect to FIG. 13, the virtual meeting system may identify key words or phrases from the audio of the virtual meeting. These phrases may include potential editing suggestions that pertain to portions of the shared document. For instance, if a color change is discussed for a specific shared document, for example a slide in a PowerPoint presentation, the virtual meeting system may propose a preview of that change within the shared document, allowing the user to accept or reject the modification. In some examples, the virtual meeting system may propose the change to the shared document while the virtual meeting is in progress. In other examples, the virtual meeting system may propose the change to the document when the user reviews or accesses the shared document after the virtual meeting has concluded.

In sequence 1400, the pre-shared content 1402 comprises the particular document that is presented during the virtual meeting, before any suggested edits have been made. At step 1414, the virtual meeting system retrieves the pre shared content. At step 1416, the content analysis module 1404 analyzes the pre shared content and comments to identify potential edits to the pre shared content. At step 1418, the virtual meeting system identifies the transcribed comments 1406 captured during presentation of the pre shared content during the virtual meeting, and identifies and provides suggested edits to the API interface 1408.

At step 1420, the API interface 1408 generates the edit suggestions within the pre shared document using the pre shared document's native application API. The virtual meeting system then generates a real time preview 1410 of the edit suggestion, and displays the proposed change to the user within the pre shared document via the user interface 1412 at step 1422. The user may also be presented with a prompt to accept or reject the edit suggestion.

For example, if a comment during the presentation of a particular document in a virtual meeting mentioned “Change the font in the second paragraph from Helvetica Neue to Myriad Pro, because Helvetica Neue is clearly a much better font,” the virtual meeting system may identify the second paragraph of the presented document (and the page that was being presented when the comment was made during the virtual meeting) and may create a highlighted marker indicating the comment's location within the particular document. In other examples, the user interface may display a preview pane that suggests an alternative example or rephrasing of a portion of text, based on the comment's intent. As noted above, these examples (and others) may make use of large language models or other techniques for analyzing audio associated with the presentation of a document.

In some examples, the virtual meeting system may identify the format and type of the pre-shared content. Each content type, for example a Word document, a PowerPoint presentation, or a PDF, may have its own associated native application with specific APIs and markup protocols. The virtual meeting system may establish a connection with the respective application's API, and using that API's functionality, the virtual meeting system may access the internal structure of the content, like paragraphs, headings, bullet points, or images. Then, by cross-referencing the transcribed comments from the virtual meeting with this structured data of the shared content, the virtual meeting system may isolate sections of the content that the comments pertain to. Upon recognizing a comment that might suggest an edit to the shared document, the system may use the API to generate a real-time preview of that suggested change. The APIs provide functionalities to tweak the content, adjust formatting, or introduce new elements, based on the comments' directives.

In some examples, the virtual meeting system may compile the edit suggestions for a particular document and may present the edit suggestions to the user in a structured manner, allowing them to navigate through each suggested edit. The user can then decide to accept, modify, or reject each suggestion.

In some examples, the virtual meeting system may keep track of edits made to the shared content after the content was presented during a virtual meeting. The virtual meeting system may then store audio/video commentary and associated transcript/edit suggestions associated with a version of the content (e.g., embedded within the document). Illustratively, if during the presentation of a particular document it was suggested that a portion of the particular document be modified in a certain way, and later a user with access to the particular document modified the content in line with what was suggested during the presentation of the content, the system may mark the associated audio/video portion suggesting the modification as not applicable (or “resolved”) to that new version of the content. The virtual meeting system may attempt to keep the metadata associated with a version of the shared content in sync with the version that was presented.

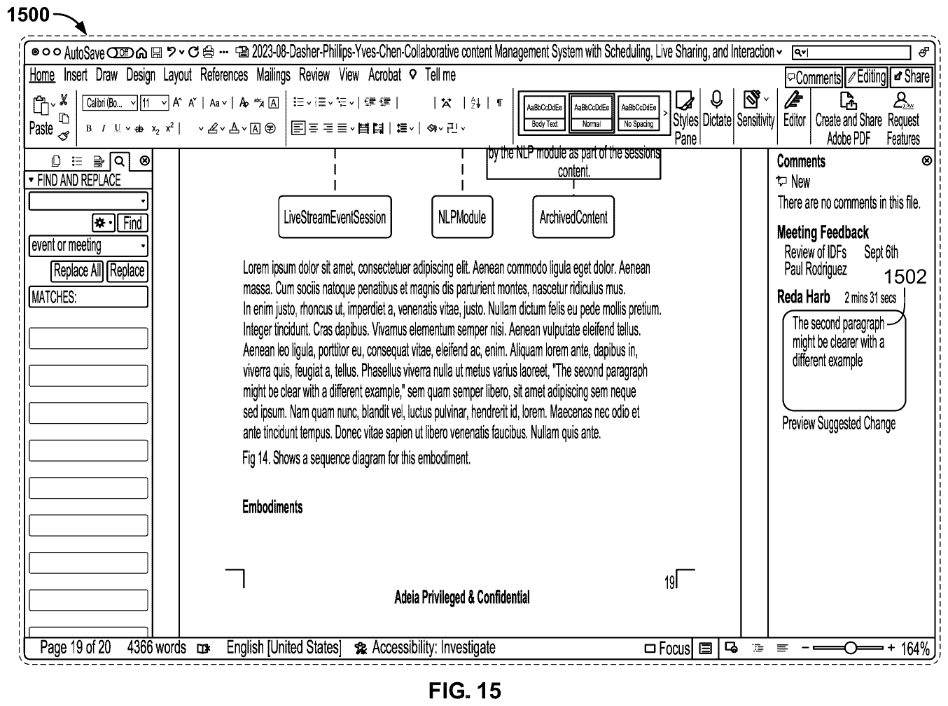

FIG. 15 illustrates an example user interface of a shared document 1500 after the virtual meeting in which it was presented has concluded. During the virtual meeting, for example, one of the participants made a comment that “the second paragraph may be clearer with a different example.” The virtual meeting system analyzed the audio from this user, and identified this comment as being associated with a particular portion of the shared document (i.e., as discussed above with respect to FIG. 13. In response, the virtual meeting system interacted with the Word API to create a Word native comment 1502, and added that comment to the shared document. Then, when the user later opens the shared document to review, the comment made during the virtual meeting related to this portion of the shared document is included as a comment in the native shared document. The virtual meeting system may also, via the API, highlight or emphasize the relevant portion of the shared document to which the comment relates.

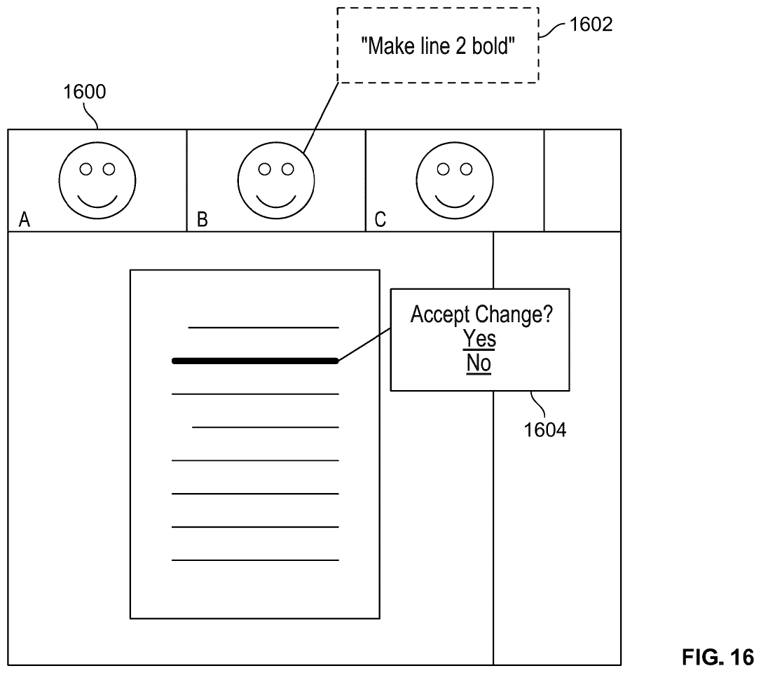

FIG. 16 depicts an illustrative user interface 1600 wherein an edit suggestion is identified and displayed during the presentation of a shared document. As noted above, the virtual meeting system may identify edit suggestions both during a virtual meeting, as well as after the virtual meeting has concluded. The same process described above may apply during the virtual meeting itself, with minor differences of timing. For example, during the virtual meeting itself, the NLP module may analyze the participants' audio to identify edit suggestions (e.g., edit suggestion 1602). These suggestions may be added as comments to the shared document via the relevant application API (as noted above). Additionally, the virtual meeting system may apply the edit suggestion 1602 to the shared document itself, and may present a preview of the changed document to the user including the edit suggestion 1602. As shown in FIG. 16, when a participant suggests “make line two bold,” the virtual meeting system may change the shared document, and may present a prompt 1604 requesting the user accept or reject the edit suggestion.

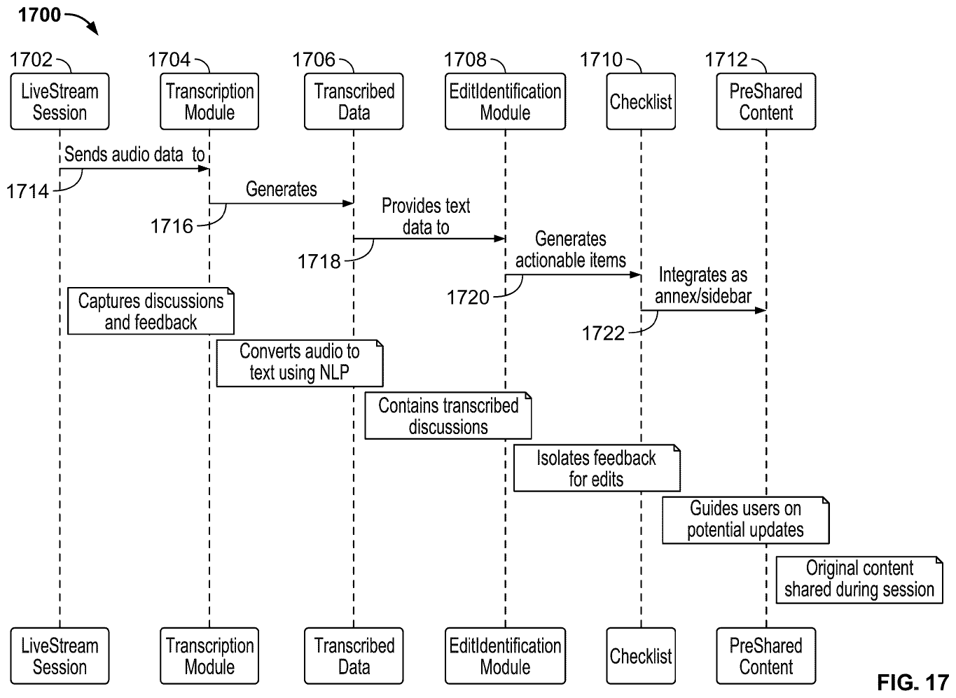

FIG. 17 depicts an illustrative sequence diagram 1700 showing how a checklist may be created for a shared document based on commentary during a virtual meeting. As noted above, audio captured during the presentation of a shared document during a virtual meeting may be analyzed using NLP. Based on the transcribed and analyzed audio, the virtual meeting system may identify edit suggestions and may link them with the relevant portions of the document based on the timecodes of when the comments were made and when various portions of the shared document were displayed during the virtual meeting. The virtual meeting system may then create a checklist or other structured list of these comments, and may add this checklist to the pre-shared content stored in the shared storage.

In the sequence 1700 at step 1714, the live stream session 1702 may capture the discussions and audio from the virtual meeting and transmit it to the transcription module 1704. At step 1716, the transcription module 1704 converts the audio from the virtual meeting to text using NLP and generates transcribed data 1706. At step 1718, the transcribed audio is provided to the edit identification module 1708. At step 1720, the edit identification module 1708 identifies edit suggestions or other relevant comments from the transcribed audio, and generates actionable items. These actionable items are compiled into a checklist 1710. At step 1722, the checklist is presented to user within the native application of the pre shared content 1712.

In some cases, the checklist is generated so that the comments are list in the order based on the presented document. That is, if the discussion during the virtual meeting jumped around with respect to the document (e.g., discussing page 4, then page 10, then page 6), the checklist may be ordered such that the comments regarding page 4 are first, then those regarding page 6, then those regarding page 10. This enables a user to quickly scroll through the shared document to review comments from the virtual meeting relevant to the document in the order of the document itself. In other examples, the checklist may be generated such that the comments are listed in chronological order in which they were made during the virtual meeting. The checklist may be presented as a comment or comments with the shared document, as a sidebar within the document, or in some other format depending on the type of document presented.

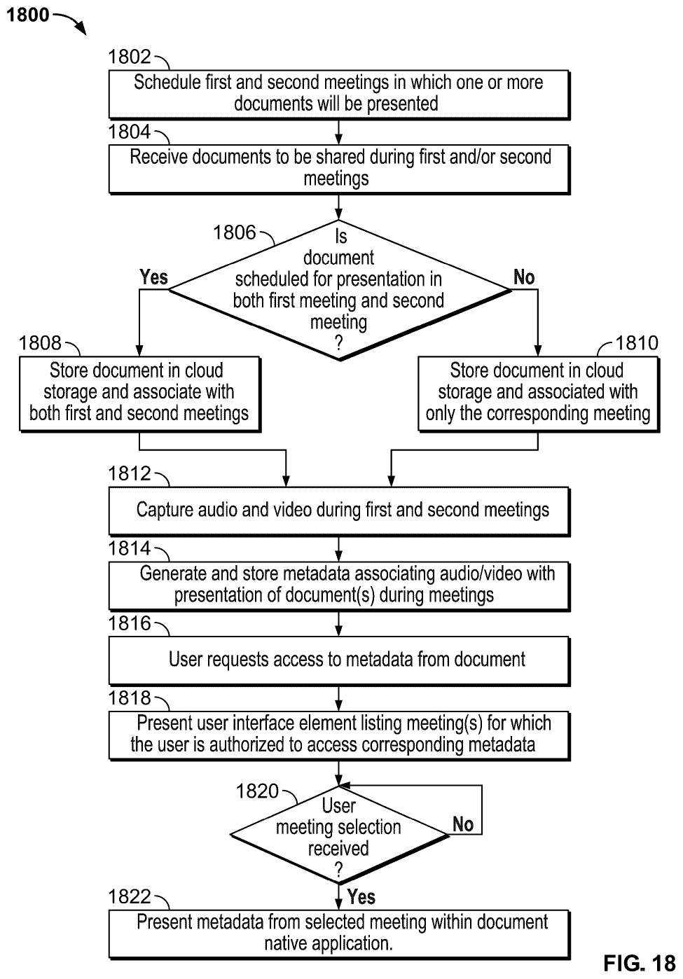

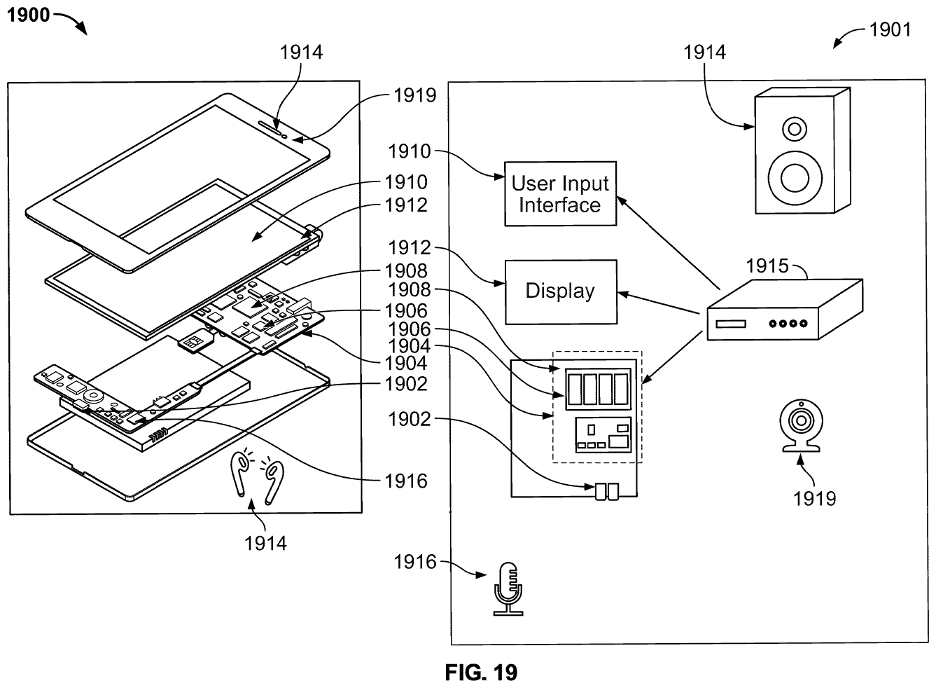

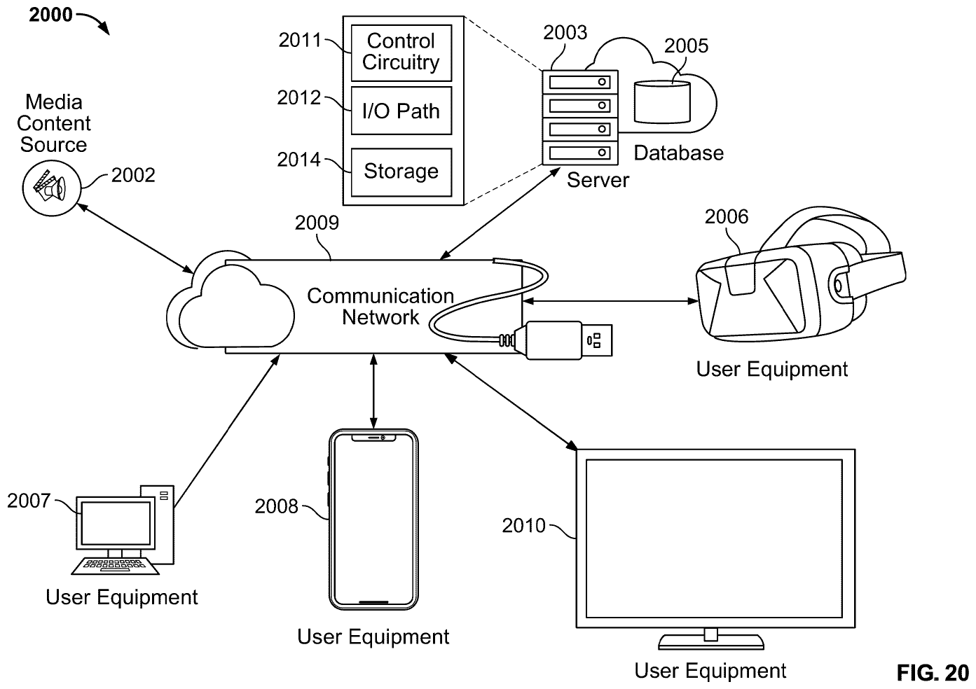

FIG. 18 is a flowchart of an illustrative process 1800 for presenting options to a user to access communication data associated with multiple different virtual meetings in which a particular document was presented, in accordance with some embodiments of this disclosure. In various embodiments, the individual steps of process 1800 may be implemented by one or more components of the computing devices and systems of FIGS. 19-20 and may be performed in combination with any of the other processes and aspects described herein. Although the present disclosure may describe certain steps of process 1800 (and of other processes described herein) as being implemented by certain components of the computing devices and systems of FIGS. 1-20, this is for purposes of illustration only. It should be understood that other components of the computing devices and systems of FIGS. 1-20 may implement those steps instead.

At step 1802, control circuitry (e.g., control circuitry 1904 of FIG. 19 and/or control circuitry 2011 of FIG. 20) may schedule first and second virtual meetings in which one or more particular documents (which may be the same particular document) will be presented. The virtual meetings may be scheduled for various times, may have different sets of participants, and/or may have different hosts and/or presenters. One common aspect of each virtual meeting, however, may be that the same particular document is scheduled to be presented during both virtual meetings. The first and second virtual meetings may correspond to the virtual meetings discussed elsewhere in this disclosure with respect to FIGS. 1-17.

At step 1804, the control circuitry and/or input/output circuitry receives one or more particular documents that are scheduled to be shared during either or both of the scheduled first and/or second virtual meetings. This may be similar or identical to the process described above with respect to FIGS. 2A-C, 5 and/or 6. In some examples, a particular document may be input into a widget or application associated with a particular virtual meeting (e.g., the first virtual meeting or the second virtual meeting). In other examples, a particular document may be input to the system and associated with multiple scheduled virtual meetings. The user may select the particular document, and/or select one or more virtual meetings which have already been or will be scheduled, and during which the selected document is expected to be shared.

At step 1806, the control circuitry determines whether the input, received, or selected document is scheduled for presentation in both the first virtual meeting and the second virtual meeting, as well as one or more other virtual meetings. In some examples, a user may schedule a first virtual meeting, and upload or select a first document that will be shared during that virtual meeting (e.g., as described above). The same user may then schedule a second virtual meeting, and upload or select a second document that will be shared during that virtual meeting. The control circuitry may determine that the first document and the second document are the same by comparing the document titles, contents, and/or other identifiers associated with each document.

At step 1808, if the same particular document is identified as being scheduled for presentation in both the first virtual meeting and the second virtual meeting, the control circuitry may store the particular document in the cloud storage and associate the particular document with both the first and second virtual meetings. That is, the cloud storage may store a single copy of the particular document, along with metadata or other information identifying each scheduled virtual meeting in which the particular document is scheduled for presentation (e.g., embedded within the document).

Alternatively, if the particular document is identified as being scheduled for presentation in only one of the first virtual meeting or the second virtual meeting, the control circuitry at step 1810 may store the particular document in the cloud storage and associate the particular document with only that virtual meeting for which the received document is scheduled for presentation.

At step 1812, the control circuitry then captures virtual meeting communication data including audio and/or video during the first and second virtual meetings. The audio may be input by the participants of the first and second virtual meetings. The control circuitry may capture audio and video for each virtual meeting separately. The control circuitry may also capture timestamps or timecodes associated with when audio is captured, which portion of the particular document is being presented during the virtual meeting, and more. This step may be similar or identical to the process described above with respect to FIG. 8.

At step 1814, the control circuitry may generate and store metadata (e.g., embedded within the document) associating the recorded audio and video (e.g., virtual meeting communication data) from the respective first and second virtual meetings with the presentation of the particular document during those virtual meetings. That is, the control circuitry may generate and store metadata linking the recorded audio and video (as well as transcriptions of the audio, text, or other data) with the presented document, and in particular with the portions of the particular document that were displayed when the communication data from the participants of the virtual meeting was received. This enables the control circuitry to link together specific portions of the particular document with the commentary that was made during the virtual meeting when those specific portions of the particular document were being presented and discussed.

At step 1816, after the conclusion of both the first virtual meeting and the second virtual meeting, a user may request access to the metadata associated with the first and/or second virtual meetings with respect to the particular documents shared during those virtual meetings. For instance, the presenter of the particular document shared during both the first virtual meeting and the second virtual meeting may wish to review the discussion that was had with respect to the particular document from one or both of the first and second virtual meetings. The presenter may open the shared document within the native application of that document (e.g., by opening Word, PowerPoint, etc.).

At step 1818, the control circuitry may present a user interface element listing the virtual meeting(s) for which the requesting user is authorized to access the corresponding metadata that is associated with the presentation of that particular document. A given user may be restricted to accessing the virtual meeting commentary (e.g., virtual meeting communication data) from only those virtual meetings in which they were a participant, or have otherwise been granted access. The control circuitry may compare the requesting user's identity to the list of participants of the one or more virtual meetings in which the particular document was presented. The control circuitry may then present to the user a list of all the virtual meetings in which the particular document was presented and for which the user is authorized to access the associated metadata. This step may be similar or identical to the process shown in and described with respect to FIG. 9.

At step 1820, the control circuitry determines whether a user input selecting one of the available virtual meetings during which the particular document was presented has been received. And at step 1816, once a selection has been received, the control circuitry presents the metadata from the selected virtual meeting. In some examples, the metadata may be presented as native comments within the particular document itself, as discussed above with respect to FIGS. 9, 13, 14, and 15. The process 1800 may then end.

FIGS. 19-20 depict illustrative devices, systems, servers, and related hardware for enhancing the user experience in event live streaming applications, such as are described above, in accordance with some embodiments of this disclosure. FIG. 19 shows generalized embodiments of illustrative computing devices 1900 and 1901, which may correspond to, e.g., computing devices described with respect to FIGS. 1-18, or any suitable device configured to join a virtual meeting and carry out the functions described herein. For example, computing device 1900 may be a smartphone device, a tablet, a near-eye display device, a XR (e.g., virtual reality or augmented reality or mixed reality) computing device, or any other suitable device capable of participating in an interactive video session or other media virtual meeting (e.g., in real time or otherwise) over a communication network. In another example, computing device 1901 may be laptop or desktop computer system or device. Computing device 1901 may include computing system 1915. Computing system 1915 may be communicatively connected to microphone 1916, audio output equipment (e.g., speaker or headphones 1914), and display 1912. In some embodiments, microphone 1916 may receive audio corresponding to a voice of a video conference participant and/or ambient audio data during a video conference. In some embodiments, display 1912 may be a television display or a computer display. In some embodiments, computing system 1915 may be communicatively connected to user input interface 1910. In some embodiments, user input interface 1910 may be a remote control device. Computing system 1915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 20. In some embodiments, computing device 1900 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 1900. In some embodiments, computing device 1900 comprises a rechargeable battery that is configured to provide power to the components of the computing device.

Each one of computing device 1900 and computing device 1901 may receive content and data via input/output (I/O) path 1902. I/O path 1902 may provide content (e.g., broadcast programming, on-demand programming, Internet content, content available over a local area network (LAN) or wide area network (WAN), and/or other content) and data to control circuitry 1904, which may comprise processing circuitry 1906 and storage 1908. Control circuitry 1904 may be used to send and receive commands, requests, and other suitable data using I/O path 1902, which may comprise I/O circuitry. I/O path 1902 may connect control circuitry 1904 (and specifically processing circuitry 1906) to one or more communications paths (described below). I/O functions may be provided by one or more of these communications paths, but are shown as a single path in FIG. 19 to avoid overcomplicating the drawing. While computing system 1915 is shown in FIG. 19 for illustration, any suitable computing device having processing circuitry, control circuitry, and storage may be used in accordance with the present disclosure. For example, computing system 1915 may be replaced by, or complemented by, a personal computer (e.g., a notebook, a laptop, a desktop), a smartphone (e.g., computing device 1900), an XR device, a tablet, a network-based server hosting a user-accessible client device, a non-user-owned device, any other suitable device, or any combination thereof.

Control circuitry 1904 may be based on any suitable control circuitry such as processing circuitry 1906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1904 executes instructions for the virtual meeting system stored in memory (e.g., storage 1908). Specifically, control circuitry 1904 may be instructed by the virtual meeting system to perform the functions discussed above and below. In some implementations, processing or actions performed by control circuitry 1904 may be based on instructions received from the video communication application.

In client/server-based embodiments, control circuitry 1904 may include communications circuitry suitable for communicating with a server or other networks or servers. The virtual meeting system may be a stand-alone application implemented on a computing device or a server. The virtual meeting system may be implemented as software or a set of executable instructions. The instructions for performing any of the embodiments discussed herein of the virtual meeting system may be encoded on non-transitory computer-readable media (e.g., a hard drive, random-access memory on a DRAM integrated circuit, read-only memory on a BLU-RAY disk, etc.). For example, in FIG. 19, the instructions may be stored in storage 1908, and executed by control circuitry 1904 of a computing device 1900.

In some embodiments, the virtual meeting system may be a client/server application where only the client application resides on computing device 1900, and a server application resides on an external server (e.g., server 2004 of FIG. 20). For example, the virtual meeting system may be implemented partially as a client application on control circuitry 1904 of computing device 1900 and partially on server 2004 as a server application running on control circuitry 2011. Server 2004 may be a part of a local area network with one or more of computing devices 1900, 1901 or may be part of a cloud computing environment accessed via the internet. In a cloud computing environment, various types of computing services for performing searches on the internet or informational databases, providing video communication capabilities, providing storage (e.g., for a database) or parsing data are provided by a collection of network-accessible computing and storage resources (e.g., server 2004 and/or an edge computing device), referred to as “the cloud.” Computing device 1900 may be a cloud client that relies on the cloud computing capabilities from server 2004 to perform various functions described herein. When executed by control circuitry of server 2004, the virtual meeting system may instruct control circuitry 1911 to perform such tasks. The client application may instruct control circuitry 1904 to determine such tasks. In some embodiments, the video conference may correspond to one or more of online meetings, virtual meeting rooms, video calls, Internet Protocol (IP) video calls, etc.

Control circuitry 1904 may include communications circuitry suitable for communicating with a video communication or video conferencing server, XR content servers, social networking servers, video gaming servers, edge computing systems and devices, a table or database server, or other networks or servers. The instructions for carrying out the above mentioned functionality may be stored on a server (which is described in more detail in connection with FIG. 20). Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 20). In addition, communications circuitry may include circuitry that enables peer-to-peer communication of computing devices, or communication of computing devices in locations remote from each other (described in more detail below).

Memory may be an electronic storage device provided as storage 1908 that is part of control circuitry 1904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1908 may be used to store various types of content described herein as well as virtual meeting system data described above. Nonvolatile memory may also be used (e.g., to launch a boot-up routine and other instructions). Cloud-based storage may be used to supplement storage 1908 or instead of storage 1908.

Control circuitry 1904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 1904 may also include scaler circuitry for upconverting and downconverting content into the preferred output format of computing device 1900. Control circuitry 1904 may also include digital-to-analog converter circuitry and analog-to-digital converter circuitry for converting between digital and analog signals. The tuning and encoding circuitry may be used by computing device 1900, 1901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to manage simultaneous tuning functions (e.g., watch and record functions, picture-in-picture (PIP) functions, multiple-tuner recording, etc.). If storage 1908 is provided as a separate device from computing device 1900, the tuning and encoding circuitry (including multiple tuners) may be associated with storage 1908.

Control circuitry 1904 may receive instruction from a user by way of user input interface 1910. User input interface 1910 may be any suitable user interface, such as a remote control, mouse, trackball, keypad, keyboard, touch screen, touchpad, stylus input, joystick, voice recognition interface, or other user input interfaces. Display 1912 may be provided as a stand-alone device or integrated with other elements of each one of computing device 1900 and computing device 1901. For example, display 1912 may be a touchscreen or touch-sensitive display. In such circumstances, user input interface 1910 may be integrated with or combined with display 1912. In some embodiments, user input interface 1910 includes a remote-control device having one or more microphones, buttons, keypads, any other components configured to receive user input or combinations thereof. For example, user input interface 1910 may include a handheld remote-control device having an alphanumeric keypad and option buttons. In a further example, user input interface 1910 may include a handheld remote-control device having a microphone and control circuitry configured to receive and identify voice commands and transmit information to computing system 1915.

Audio output equipment 1914 may be integrated with or combined with display 1912. Display 1912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1912. Audio output equipment 1914 may be provided as integrated with other elements of each one of computing device 1900 and computing device 1901 or may be stand-alone units. An audio component of videos and other content displayed on display 1912 may be played through speakers (or headphones) of audio output equipment 1914. In some embodiments, audio may be distributed to a receiver (not shown), which processes and outputs the audio via speakers of audio output equipment 1914. In some embodiments, for example, control circuitry 1904 is configured to provide audio cues to a user, or other audio feedback to a user, using speakers of audio output equipment 1914. There may be a separate microphone 1916 or audio output equipment 1914 may include a microphone configured to receive audio input such as voice commands or speech. For example, a user may speak letters or words that are received by the microphone and converted to text by control circuitry 1904. In a further example, a user may voice commands that are received by a microphone and recognized by control circuitry 1904. Camera 1919 may be any suitable video camera integrated with the equipment or externally connected. Camera 1919 may be a digital camera comprising a charge-coupled device (CCD) and/or a complementary metal-oxide semiconductor (CMOS) image sensor. Camera 1919 may be an analog camera that converts to digital images via a video card.

The virtual meeting system may be implemented using any suitable architecture. For example, it may be a stand-alone application wholly implemented on each one of computing device 1900 and computing device 1901. In such an approach, instructions of the application may be stored locally (e.g., in storage 1908), and data for use by the application is downloaded on a periodic basis (e.g., from an out-of-band feed, from an Internet resource, or using another suitable approach). Control circuitry 1904 may retrieve instructions of the application from storage 1908 and process the instructions to provide video conferencing functionality and generate any of the displays discussed herein. Based on the processed instructions, control circuitry 1904 may determine what action to perform when input is received from user input interface 1910. For example, movement of a cursor on a display up/down may be indicated by the processed instructions when user input interface 1910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1904 may allow a user to provide user profile information or may automatically compile user profile information. For example, control circuitry 1904 may access and monitor network data, video data, audio data, processing data, participation data from a conference participant profile. Control circuitry 1904 may obtain all or part of other user profiles that are related to a particular user (e.g., via social media networks), and/or obtain information about the user from other sources that control circuitry 1904 may access. As a result, a user can be provided with a unified experience across the user's different devices.

In some embodiments, the virtual meeting system is a client/server-based application. Data for use by a thick or thin client implemented on each one of computing device 1900 and computing device 1901 may be retrieved on-demand by issuing requests to a server remote to each one of computing device 1900 and computing device 1901. For example, the remote server may store the instructions for the application in a storage device. The remote server may process the stored instructions using circuitry (e.g., control circuitry 1904) and generate the displays discussed above and below. The client device may receive the displays generated by the remote server and may display the content of the displays locally on computing device 1900. This way, the processing of the instructions is performed remotely by the server while the resulting displays (e.g., that may include text, a keyboard, or other visuals) are provided locally on computing device 1900. Computing device 1900 may receive inputs from the user via input interface 1910 and transmit those inputs to the remote server for processing and generating the corresponding displays. For example, computing device 1900 may transmit a communication to the remote server indicating that an up/down button was selected via input interface 1910. The remote server may process instructions in accordance with that input and generate a display of the application corresponding to the input (e.g., a display that moves a cursor up/down). The generated display may then be transmitted to computing device 1900 for presentation to the user.

In some embodiments, the virtual meeting system may be downloaded and interpreted or otherwise run by an interpreter or virtual machine (run by control circuitry 1904). In some embodiments, the virtual meeting system may be encoded in the ETV Binary Interchange Format (EBIF), received by control circuitry 1904 as part of a suitable feed, and interpreted by a user agent running on control circuitry 1904. For example, the virtual meeting system may be an EBIF application. In some embodiments, the virtual meeting system may be defined by a series of JAVA-based files that are received and run by a local virtual machine or other suitable middleware executed by control circuitry 1904. In some of such embodiments (e.g., those employing MPEG-2, MPEG-4, HEVC or any other suitable digital media encoding schemes), portions of the virtual meeting system (e.g., recordings) may be, for example, encoded and transmitted in an MPEG-2 object carousel with the MPEG audio and video packets of a program.

As shown in FIG. 20, devices 2006, 2007, 2008, and 2010 may be coupled to communication network 2009. In some embodiments, each of computing devices 2006, 2007, 2008, and 2010 may correspond to one of computing devices 1900 or 1901 of FIG. 19, or any other suitable device capable of joining a virtual meeting, or any combination thereof. Communication network 2009 may be one or more networks including the Internet, a mobile phone network, mobile, voice or data network (e.g., a 5G, 4G, or LTE network), cable network, public switched telephone network, or other types of communication network or combinations of communication networks. Paths (e.g., depicted as arrows connecting the respective devices to the communication network 2009) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 20 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 2009.

System 2000 may comprise media content source 2002, one or more servers 2004, and/or one or more edge computing devices. In some embodiments, the virtual meeting system may be executed at one or more of control circuitry 2011 of server 2004 (and/or control circuitry of computing devices 2006, 2007, 2008, 2010 and/or control circuitry of one or more edge computing devices). In some embodiments, media content source 2002 and/or server 2004 may be configured to host or otherwise facilitate communication sessions between computing devices 2006, 2007, 2008, 2010 and/or any other suitable devices, and/or host or otherwise be in communication (e.g., over network 2009) with one or more social network services.

In some embodiments, server 2004 may include control circuitry 2011 and storage 2014 (e.g., RAM, ROM, Hard Disk, Removable Disk, etc.). Storage 2014 may store one or more databases. Server 2004 may also include an input/output path 2012. I/O path 2012 may provide video conferencing data, device information, or other data, over a local area network (LAN) or wide area network (WAN), and/or other content and data to control circuitry 2011, which may include processing circuitry, and storage 2014. Control circuitry 2011 may be used to send and receive commands, requests, and other suitable data using I/O path 2012, which may comprise I/O circuitry. I/O path 2012 may connect control circuitry 2011 (and specifically control circuitry) to one or more communications paths.

Control circuitry 2011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 2011 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 2011 executes instructions for an emulation system application stored in memory (e.g., the storage 2014). Memory may be an electronic storage device provided as storage 2014 that is part of control circuitry 2011.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method comprising:
receiving an input to schedule a first virtual meeting, wherein the first virtual meeting is scheduled to include a first plurality of participants including a first participant associated with a first computing device of a first plurality of computing devices and a second participant associated with a second computing device of the first plurality of computing devices, the first and second computing devices being connected via a network to a server providing the first virtual meeting;
receiving, prior to a start of the first virtual meeting, a particular document to be presented to the first plurality of participants during the first virtual meeting;
storing the particular document in a cloud storage associated with the first virtual meeting;
storing, at the cloud storage as first metadata associated with the particular document, first virtual meeting communication data captured via at least one of the first plurality of computing devices while the particular document is being presented at the first virtual meeting;
determining that a second virtual meeting is scheduled to occur during which the particular document is scheduled to be presented, the second virtual meeting including a second plurality of participants, wherein the second plurality of participants includes the first participant;
storing, at the cloud storage as second metadata associated with the particular document, second virtual meeting communication data captured via at least one of the second plurality of computing devices while the particular document is being presented at the second virtual meeting; and
causing display, at the first computing device:
a first option to access, via the first metadata stored at the cloud storage, the first virtual meeting communication data captured while the particular document was presented during the first virtual meeting; and
a second option to access, via the second metadata stored at the cloud storage, the second virtual meeting communication data captured while the particular document was presented during the second virtual meeting.

2. The method of claim 1, further comprising:
assigning permissions associated with the particular document for the first plurality of participants based on a status of each of the first plurality of participants with respect to the first virtual meeting, wherein the permissions permit access to control presentation of the particular document during the first virtual meeting; and
during the first virtual meeting:
receiving a request to present the particular document from the first participant; and
in response to determining that a first permission corresponding to the first participant permits the first participant to control presentation of the document:
accessing the particular document stored in the cloud storage; and
providing the particular document for display on each computing device of the first plurality of participants.

3. The method of claim 1, wherein the first virtual meeting is scheduled to include at least three participants, wherein the first participant is a host of the first virtual meeting and the second participant is an author of the particular document, the method further comprising:
assigning, to the host of the first virtual meeting, permission to control presentation of the particular document during the first virtual meeting;
assigning, to the author of the particular document, permission to control presentation of the particular document during the first virtual meeting; and
assigning, to all other participants, permissions that prevent control of the presentation of the particular document during the first virtual meeting.

4. The method of claim 1, wherein the first participant of the first virtual meeting is an author of the document, the method further comprising:
during the first virtual meeting:
receiving a voice command from the author; and
controlling presentation of the particular document based on the voice command.

5. The method of claim 1, wherein the first virtual meeting communication data comprises first audio data, the method further comprising:
during presentation of the particular document during the first virtual meeting, transcribing the first audio data captured via the at least one of the first plurality of computing devices;
identifying, in the transcribed first audio data, a comment associated with a first portion of the particular document; and
storing, at the cloud storage as part of the first metadata, the comment associated with the first portion of the particular document.

6. The method of claim 1, wherein the first virtual meeting communication data comprises first audio data, the method further comprising:
during presentation of the particular document during the first virtual meeting:
identifying, based on the first audio data captured via the at least one of the first plurality of computing devices, a suggestion to modify a portion of the particular document;
generating for display a preview of the portion of the particular document including the recommended modification; and
generating for display, a prompt requesting a selection to accept or reject the recommended modification.

7. The method of claim 6, further comprising:
receiving an input selection to accept the recommended modification; and
modifying the particular document in the cloud storage to include the recommended modification.

8. The method of claim 1, wherein the first virtual meeting communication data comprises first audio data, the method further comprising:
during presentation of the particular document during the first virtual meeting, transcribing the first audio data captured via the at least one of the first plurality of computing devices;
identifying one or more recommended modifications to the particular document included in the transcribed first audio data;
generating a list of action items associated with the particular document, the action items based on the one or more recommended modifications included in the transcribed first audio data; and
storing the list of action items associated with the particular document in the cloud storage.

9. The method of claim 8, wherein each of the action items in the list of action items is associated with a corresponding portion of the particular document, and wherein storing the list of action items associated with the particular document in the cloud storage comprises storing, in the cloud storage as third metadata associated with the particular document, the list of action items.

10. The method of claim 1, further comprising:
determining a meeting permission for a user based on whether the user was a participant of the first virtual meeting or a participant of the second virtual meeting; and
based on the meeting permission for the user, enabling the user to access either the first virtual meeting communication data or the second virtual meeting communication data associated with the document.

11. A system comprising:
input/output circuitry configured to:
receive an input to schedule a first virtual meeting, wherein the first virtual meeting is scheduled to include a first plurality of participants including a first participant associated with a first computing device of a first plurality of computing devices and a second participant associated with a second computing device of the first plurality of computing devices, the first and second computing devices being connected via a network to a server providing the first virtual meeting; and
receive, prior to a start of the first virtual meeting, a particular document to be presented to the first plurality of participants during the first virtual meeting; and
control circuitry configured to:
store the particular document in a cloud storage associated with the first virtual meeting;
store, at the cloud storage as first metadata associated with the particular document, first virtual meeting communication data captured via at least one of the first plurality of computing devices while the particular document is being presented at the first virtual meeting;
determine that a second virtual meeting is scheduled to occur during which the particular document is scheduled to be presented, the second virtual meeting including a second plurality of participants, wherein the second plurality of participants includes the first participant;
store, at the cloud storage as second metadata associated with the particular document, second virtual meeting communication data captured via at least one of the second plurality of computing devices while the particular document is being presented at the second virtual meeting; and
cause display, at the first computing device:
a first option to access, via the first metadata stored at the cloud storage, the first virtual meeting communication data captured while the particular document was presented during the first virtual meeting; and
a second option to access, via the second metadata stored at the cloud storage, the second virtual meeting communication data captured while the particular document was presented during the second virtual meeting.

12. The system of claim 11, wherein the control circuitry is further configured to:
assign permissions associated with the particular document for the first plurality of participants based on a status of each of the first plurality of participants with respect to the first virtual meeting, wherein the permissions permit access to control presentation of the particular document during the first virtual meeting; and
during the first virtual meeting:
receive a request to present the particular document from the first participant; and
in response to determining that a first permission corresponding to the first participant permits the first participant to control presentation of the document:
access the particular document stored in the cloud storage; and
provide the particular document for display on each computing device of the first plurality of participants.

13. The system of claim 11, wherein the first virtual meeting is scheduled to include at least three participants, wherein the first participant is a host of the first virtual meeting and the second participant is an author of the particular document, and wherein the control circuitry is further configured to:
assign, to the host of the first virtual meeting, permission to control presentation of the particular document during the first virtual meeting;
assign, to the author of the particular document, permission to control presentation of the particular document during the first virtual meeting; and
assign, to all other participants, permissions that prevent control of the presentation of the particular document during the first virtual meeting.

14. The system of claim 11, wherein the first participant of the first virtual meeting is an author of the document, and wherein the control circuitry is further configured to:
during the first virtual meeting:
receive a voice command from the author; and
control presentation of the particular document based on the voice command.

15. The system of claim 11, wherein the first virtual meeting communication data comprises first audio data, and wherein the control circuitry is further configured to:
during presentation of the particular document during the first virtual meeting, transcribe the first audio data captured via the at least one of the first plurality of computing devices;
identify, in the transcribed first audio data, a comment associated with a first portion of the particular document; and
store, at the cloud storage as part of the first metadata, the comment associated with the first portion of the particular document.

16. The system of claim 11, wherein the first virtual meeting communication data comprises first audio data, and wherein:
the control circuitry is further configured to:
during presentation of the particular document during the first virtual meeting, identify, based on the first audio data captured via the at least one of the first plurality of computing devices, a suggestion to modify a portion of the particular document; and
the input/output circuitry is further configured to:
generate for display a preview of the portion of the particular document including the recommended modification; and
generate for display, a prompt requesting a selection to accept or reject the recommended modification.

17. The system of claim 16, wherein:
the input/output circuitry is further configured to receive an input selection to accept the recommended modification; and
the control circuitry is further configured to modify the particular document in the cloud storage to include the recommended modification.

18. The system of claim 11, wherein the first virtual meeting communication data comprises first audio data, and wherein the control circuitry is further configured to:
during presentation of the particular document during the first virtual meeting, transcribe the first audio data captured via the at least one of the first plurality of computing devices;
identify one or more recommended modifications to the particular document included in the transcribed first audio data;
generate a list of action items associated with the particular document, the action items based on the one or more recommended modifications included in the transcribed first audio data; and
store the list of action items associated with the particular document in the cloud storage.

19. The system of claim 18, wherein each of the action items in the list of action items is associated with a corresponding portion of the particular document, and wherein storing the list of action items associated with the particular document in the cloud storage comprises storing, in the cloud storage as third metadata associated with the particular document, the list of action items.

20. The system of claim 11, wherein the control circuitry is further configured to:
determine a meeting permission for a user based on whether the user was a participant of the first virtual meeting or a participant of the second virtual meeting; and
based on the meeting permission for the user, enable the user to access either the first virtual meeting communication data or the second virtual meeting communication data associated with the document.

21-50. (canceled)
